(19) United States
(12) Patent Application Publication
(10) Pub. No.: US 2026/0094489 A1
(43) Pub. Date: Apr. 2, 2026

(54) GAMING MACHINE AND METHOD WITH PERSISTENCE REVEAL FEATURE

(71) Applicant: LNW Gaming, Inc., Las Vegas, NV (US)

(72) Inventors: George BOUVIER, Henderson, NV (US); Kimberly COHN, Las Vegas, NV (US); Jessica DICKSON, Las Vegas, NV (US); Jordan DRAPER, Henderson, NV (US); Richard MILOSEVICH, Las Vegas, NV (US); Kenneth Shawn SOONG, Henderson, NV (US)

(21) Appl. No.: 19/329,639

(22) Filed: Sep. 16, 2025

Related U.S. Application Data
(60) Provisional application No. 63/701,689, filed on Oct. 1, 2024.

(51) Int. Cl. G07F 17/32

(52) U.S. Cl. CPC G07F 17/3213; G07F 17/3267

(57) ABSTRACT

Gaming systems and methods herein include a presentation assembly to present a plurality of award groups and a symbol array including a plurality of position subsets. The presentation assembly locks trigger symbols from the symbol array into the award groups and initiates corresponding subset counters. For a value-bearing trigger symbol, a presentation state is selected from a set of states comprising a full presentation state and a hidden presentation state, and the indicia of the value-bearing trigger symbol relative to an associated award value is based on the selected presentation state, where indicia matches the award value in the full presentation state and the hidden presentation state includes visually obscuring a relationship between the value-bearing trigger symbol and the full award value. Symbols in the hidden presentation state transition to the reveal the full award value in response to an award condition for the associated award group.

### CROSS-REFERENCE TO RELATED APPLICATIONS

This patent application claims the benefit of priority to U.S. Provisional Patent Application No. 63/701,689 , filed on Oct. 1, 2024, the contents of the which are incorporated herein by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024, LNW Gaming, Inc.

### FIELD OF THE INVENTION

The present invention relates to a technological improvement to gaming systems, apparatus, and methods and, more particularly, to new and improved animations in connection with a symbol array persistence feature using reveal mechanics.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

In according to one or more aspects of the present disclosure, systems and methods described provide a gaming machine include a presentation assembly configured to present a plurality of award groups and a symbol array including a plurality of symbol positions arranged into a plurality of position subsets, and game-logic circuitry in communication with the presentation assembly. The game-logic circuitry is configured to cause the presentation assembly to: (i) present a first game outcome by populating the symbol array with a plurality of randomly selected symbols from one or more sets of available symbols including trigger symbols and value-bearing symbols, each value-bearing symbols including award indicia visually indicating a respective award value associated with the value-bearing symbol, wherein the trigger symbols include one or more of the value-bearing symbols; (ii) in response to the first game outcome including at least one trigger symbol in a first subset, lock the trigger symbol(s) in a first award group that is associated with the first subset; (iii) present a subset counter associated with the first subset at an initial count in response to the first game outcome; (iv) with the at least one trigger symbol locked in the first award group, present at least one subsequent game outcome by populating the symbol array with another plurality of randomly selected symbols for each subsequent game outcome; (v) in response to detecting a value-bearing trigger symbol occupying the first subset within the subsequent game outcomes, select a presentation state of the value-bearing trigger symbol from a set of states comprising a full presentation state and a hidden presentation state; (vi) lock the value-bearing trigger symbol within the first award group based on the selected presentation state, wherein the full presentation state includes presenting the value-bearing trigger symbol with award indicia matching a first award value associated with the value-bearing trigger symbol, and the hidden presentation state includes visually obscuring a relationship between the value-bearing trigger symbol and the first award value; (vii) in response to a number of trigger symbols within the first award group meeting a trigger amount, present an award sequence to provide an award at least partially as a function of the first award value and respective award values associated with other trigger symbols in the first award group, wherein the award sequence includes updating the value-bearing trigger symbol in the hidden presentation state to the full presentation state; (viii) and in response to the subset counter meeting a termination count, remove any locked trigger symbols from the first award group. The game-logic circuitry may be separate from or at least partially integrated with the gaming machine.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to embodiments of the present invention.

FIG. 4 is a flowchart for an algorithm that corresponds to instructions executed by game-logic circuitry in accord with one or more of the present concepts.

FIGS. 5A-5F are representations of a series of game cycles of a wagering game displayed on a gaming machine in accord with one or more of the present concepts.

FIG. 6 is a flow diagram of an example method of operating a gaming machine including hidden value-bearing symbols, according to one or more concepts of the present disclosure.

FIGS. 7A-7F are representations of a series of game states of an example game using hidden award values displayed on a gaming machine, according to one or more of the present concepts.

FIGS. 8A-8F are representations of a series of game states of an example game using dedicated award groups displayed on a gaming machine and selectable award options, according to one or more of the present concepts.

FIG. 9 is a flow diagram of an example method of operating a gaming machine including hidden award symbols, according to one or more concepts of the present disclosure.

FIGS. 10A-10D depict a series of game states of an example game using upgradeable position frames displayed on gaming machine, according to one or more concepts of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

Embodiments of the present invention comprise an innovative application of data processing steps that, when implemented by game-logic circuitry, direct an electronic display device to present a symbol-value aggregation process that minimizes processing overhead by utilizing numbered indicia to represent credit values instead of complex, fanciful game images. Further, the process aggregates displayed values borne by special symbols (i.e., value-bearing symbols) according to stored, variable criteria. In this way, the value-bearing symbols provide building blocks for innumerable different aggregation sequences simply by manipulating the aggregation criteria associated with the value-bearing symbols, resulting in fewer rules needed for the aggregation process than would be necessary for calculating values of winning symbol combinations enumerated in stored paytables, as found in prior art reel-spinning routines. At the same time, embodiments of the present invention provide a straightforward, what-you-see-is-what-you-get (WYSIWYG) visual presentation that is simple to understand and, therefore, effective in generating player excitement and enthusiasm. The result is a highly flexible value-aggregation process that can be easily adapted to any theme/brand while remaining easily understood by players.

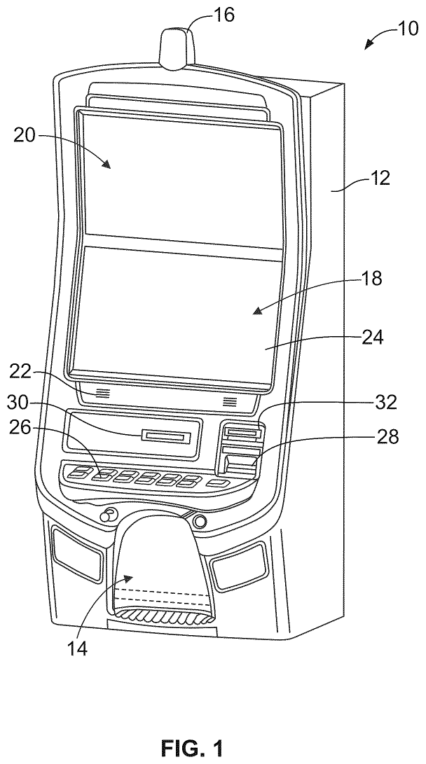

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

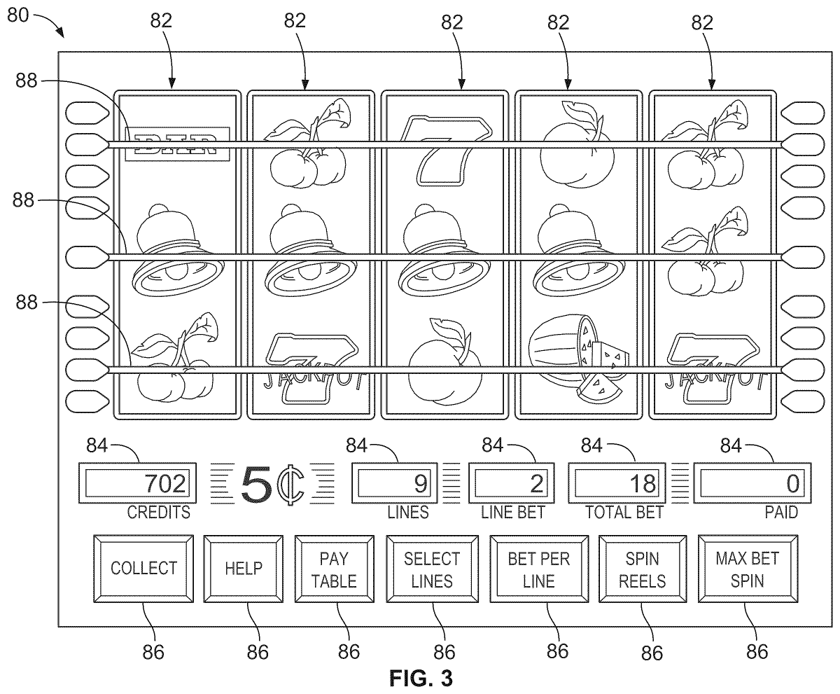

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 84 (see FIG. 3). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 84 (see FIG. 3), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

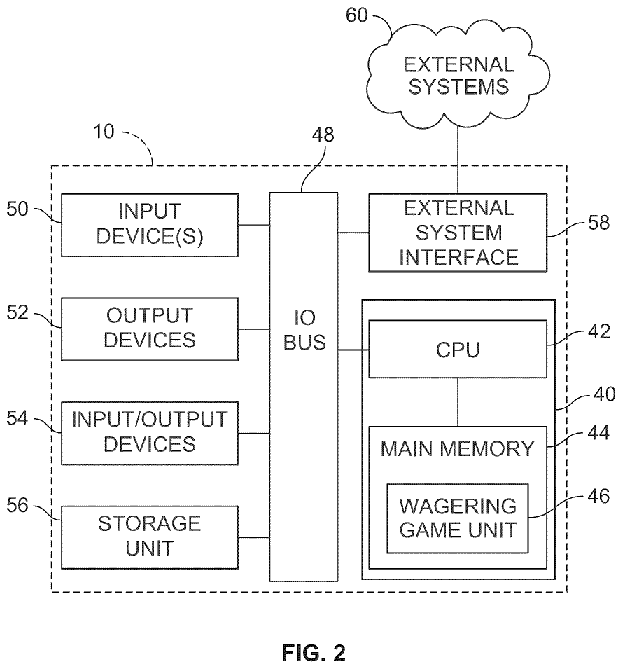

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video black jack, video slots, video lottery, etc., in whole or part.

The game-logic circuitry 40 is also connected to an input/output (I/O) bus 48, which can include any suitable bus technologies, such as an AGTL+frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compares it to a trusted code stored in the main memory 44. If the codes match, authentication is deemed a success, and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

Referring now to FIG. 3, there is illustrated an image of a basic-game screen 80 adapted to be displayed on the primary display 18 or the secondary display 20. The basic-game screen 80 portrays a plurality of simulated symbol-bearing reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 or the secondary display 20 to display the wagering game.

In response to receiving an input indicative of a wager drawn on or deducted from the credit balance on the “credits” meter 84, the reels 82 are rotated and stopped to place symbols on the reels in visual association with paylines such as paylines 88. The wagering game evaluates the displayed array of symbols on the stopped reels and provides immediate awards and bonus games in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus games based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

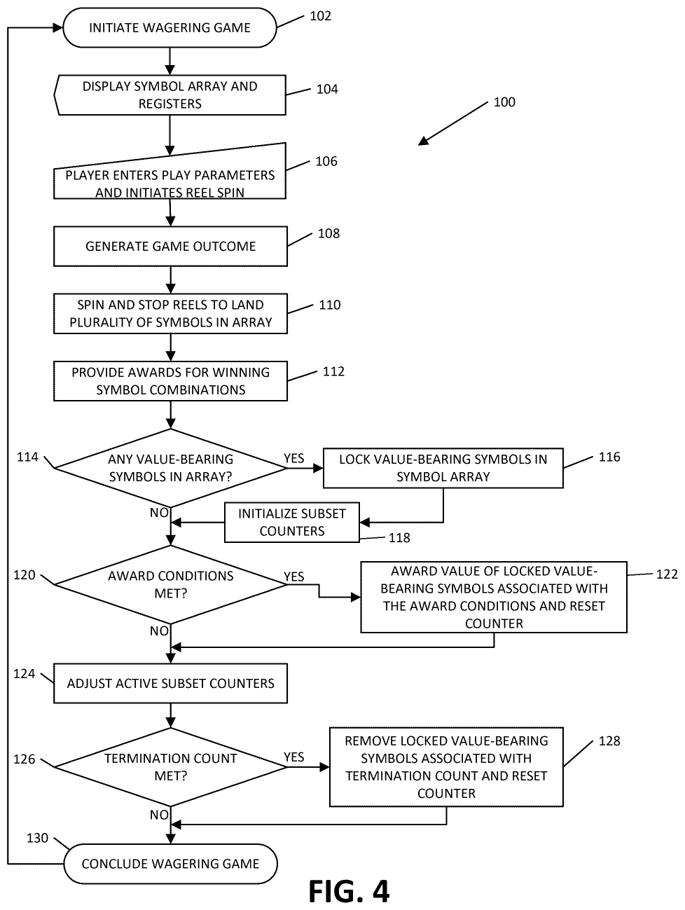

Referring now to FIG. 4, there is shown a flowchart representing a data processing method 100 corresponding to at least some instructions stored and executed by the game-logic circuitry 40 in FIG. 2 to perform operations according to one or more embodiments of the present concepts. The method 100 incorporates the use of value-bearing symbols presented by one or more display devices in communication with the game-logic circuitry 40. Value-bearing symbols are symbols that include award indicia that visibly indicate an award value associated with the value-bearing symbol. The awards associated with the value-bearing symbols include at least the indicated award values, and awards associated with multiple value-bearing symbols may aggregated the award values of the value-bearing symbols together into an aggregated award value. The method 100 uses value-bearing symbols that are held or locked into the symbol array until either one or more award conditions are met or a counter associated with the value-bearing symbols has met a termination count or value. For example, the award condition may be to fill a column with value-bearing symbols, and if this condition is met, the values indicated by the value-bearing symbols within the column are awarded. However, if a counter (e.g., a spin or game cycle counter) associated with the column reaches a termination count prior to the award condition, then the value-bearing symbols are removed from the column. In other embodiments the method 100 includes additional, fewer, or alternative steps to be performed by the game-logic circuitry 40, the display device, and/or another suitable device of the gaming system, including those steps and devices described elsewhere herein.

At step 102, the game-logic circuitry initiates a wagering game. At step 104, the game-logic circuitry directs a display of the gaming machine to display an array of symbols in the respective symbol positions. The array of symbol positions is arranged in a number of rows (e.g., three rows) by a number of columns (e.g., five columns). The symbol positions of the array may be allocated to one or more subsets for a value-bearing symbol feature described herein. In the example embodiment, each column defines a subset. In other embodiments, the subset may any other suitable grouping of symbol positions. Each subset is associated with a subset counter that is selectively initialized and terminated as described herein. At step 106, a player enters play parameters such as a wager amount to be drawn from a credit balance (deducted from a credit meter) and number of lines or ways along which winning symbol combinations must appear. To initiate a spin of the reels, the player may press a “Spin Reels” or “Max Bet” key on a button panel or touch screen. At step 108, in response to the player initiating the reel spin, the game-logic circuitry generates a random game outcome. At step 110, the game-logic circuitry spins and stops the reels to land a plurality of symbols in the displayed array according to the selected game outcome. At step 112, the game-logic circuitry provides awards for any winning symbol combinations (e.g., line pays and scatter pays) in the array.

At step 114, the game-logic circuitry determines whether or not the landed plurality of symbols include any value-bearing symbols. If one or more value-bearing symbols are included within the landed plurality of symbols, the game-logic circuitry then locks any value-bearing symbols to the symbol array at step 116 such that the locked value-bearing symbols remain within the symbol array through one or more subsequent spins. Each value-bearing symbol may be locked to a symbol position, row, or column, such as the symbol position, row, or column in which the value-bearing symbol occupied as part of the landed plurality of symbols.

At step 118, for subsets of the symbol array that did not include locked value-bearing symbols prior to the game outcome and are now occupied by one or more locked value-bearing symbols from step 116, a respective subset counter is initialized. The respective subset counter is initialized to an initial count or value. In at least some embodiments, the initial count is predetermined. In other embodiments, the initial count may be variable according to one or more parameters (e.g., randomly generated values, wager amount, player history, etc.). In the example embodiment, the subset counters are configured to count spins or game outcomes. In other embodiments, the subset counters may be configured to count a different parameter of the game, such as a number of outcomes with or without a particular symbol.

At step 120, the game-logic circuitry determines whether or not award conditions have been met for at least some of the locked value-bearing symbols. In the example embodiment, the award conditions include locking value-bearing symbols in every symbol position of a particular subset. In other embodiments, the award conditions may not require the entire subset be filled with value-bearing symbols, but rather a trigger amount of value-bearing symbols be reached. Additionally or alternatively, other suitable conditions within the symbol array may be incorporated within the award conditions.

At step 122, if the award conditions have been met (i.e., the number of value-bearing symbols has reached the trigger amount), the values visually indicated on the locked value-bearing symbols associated with the award conditions are awarded and the associated value-bearing symbols are removed or unlocked from the symbol array. That is, the value-bearing symbols may be removed immediately to reveal an underlying symbol or a blank space in its place on the symbol array until another spin or game cycle of the game is conducted. Unlocking the value-bearing symbols may cause the value-bearing symbols to ‘spin’ with other symbols in the symbol array, thereby freeing the underlying symbol position for a new symbol (including a subsequent value-bearing symbol) to land within. In some embodiments, achieving the award conditions for one subset may result in every value-bearing symbol within the array being removed or unlocked. It is to be understood that the award conditions of each subset may be at least partially independent from each other such that the award conditions for multiple subsets may be met during the same game outcome. In such an outcome, awards for each winning subset may be provided simultaneously.

At step 124, the game-logic circuitry adjusts any initialized subset counters (referred to herein as “active counters” or “active subset counters”) based on the game outcome. More specifically, the game-logic circuitry adjusts the active counters for at least three different states of the associated subset: (i) an award condition has been met; (ii) additional value-bearing symbols have been locked into the subset; and (iii) no new value-bearing symbols have been locked into the subset. A fourth state in which an inactive counter is initialized or activated is addressed by the step 118, and no additional changes are made to the newly activated counter by the game-logic circuitry.

In the first state in which an award condition was met, the locked value-bearing symbols have been removed or unlocked from the symbol array and a corresponding award has been provided. As a result, the game-logic circuitry deactivates the subset counter associated with the subset that included the removed or unlocked symbols. The subset counter is reverted to an inactive state until a subsequent game outcome includes a value-bearing symbol within the associated subset, thereby initializing the subset counter at step 118.

In the second state in which one or more additional value-bearing symbols have landed within a subset associated with an active subset counter, the subset counter is adjusted to, towards, or beyond the initial count. That is, the current count of the subset counter may be incremented or decremented towards the initial count, or the current count may be set to a predefined value (including being reset to the initial count). In the example embodiment, the count may be incremented or decremented by one. In certain embodiments, the count is incremented or decremented by a value other than one. This adjustment facilitates ‘streaks’ that perpetuate the feature in response to positive game outcomes that continue to approach the award conditions (i.e., accruing additional value-bearing symbols in a particular subset).

Other suitable mathematical operations may be used to adjust the counter as well. The adjustments may also be based on the current count and/or other conditions. For example, the amount by which the counter increases or decreases may be at least partially a function of the current count and/or a randomly generated value. In another example, each subset may have different adjustment configurations. In other embodiments, the subset counter may remain unchanged (i.e., the current count does not change) in the second state. It is to be understood that although the foregoing adjustments were described with respect to the second state, these adjustments may be equally applicable to other states resulting in the adjustment of the subset counters.

For the third state, in contrast to the second state, if no additional value-bearing symbols are detected in a subset, then the subset counter is adjusted away from the initial counter and towards a termination count. For example, if the initial count is three and the termination count is zero, the counter may be decremented by one for each spin or outcome in which no additional value-bearing symbols are detected in the subset.

At step 126, in response to the subset counter adjustments of step 124, the game-logic circuitry determines if any of the active subset counters have met a termination count. If the termination count has been met by a subset counter, the game-logic circuitry removes or unlocks any locked value-bearing symbols from the associated subset and deactivates the subset counter at step 128. The aggregated value of the removed value-bearing symbols is not awarded at step 128. That is, in the example embodiment, the aggregated value of the locked value-bearing symbols in a subset is only awarded in response to one or more award conditions being met for that particular subset (e.g., filling the subset with value-bearing symbols). In other embodiments, at least a portion the aggregated value may be stored (at least temporarily) in a register or other suitable game element as described in one of the foregoing embodiments to facilitate ‘redemption awards’ through additional game features.

The game-logic circuitry concludes the current game cycle at step 130 following either a determination at step 126 that no termination count has been met by any active subset counters or in response to step 128. Subsequent game cycles may proceed according to at least some of the steps of the method 100. It is to be understood that although the steps of the method 100 have been described in a particular order, other embodiments may include additional, fewer, or alternative steps and/or reorder the described steps 102-130. For example, steps 114-128 may be reordered, and these steps may occur at any point between the outcome being generated at step 108 and concluding the game cycle at step 130.

In certain embodiments, the award conditions and the subset counters are not aligned with each other to a single position subset. For example, the award conditions may include collecting symbols across a plurality of position subsets and/or individual locked symbols have respective counters for each locked symbol. In at least one embodiment, the game-logic circuitry monitors for award conditions for each respective position subset, and each locked symbol is associated with a respective counter rather than a subset counter for the entire position subset. In such embodiments, one or more reset symbols or combinations of reset symbols may be used to reset the count of any active counters in the symbol positions or respective position subsets, or a reset condition may not be provided for the locked symbol counters.

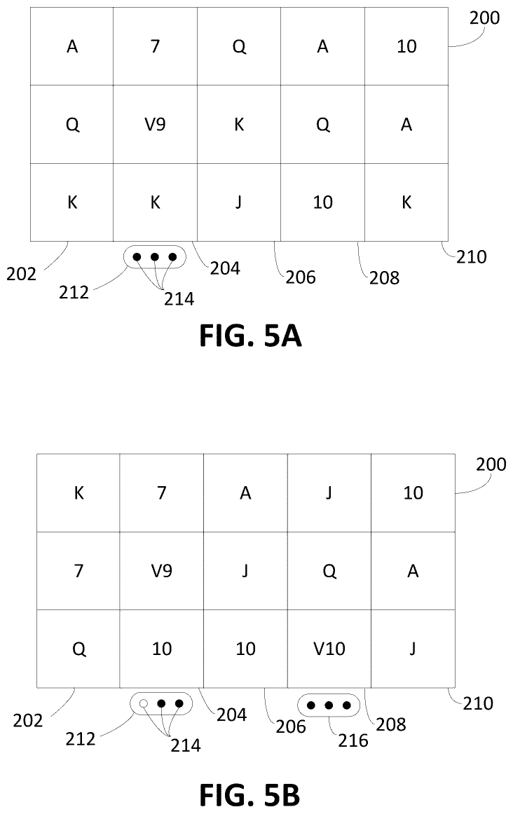

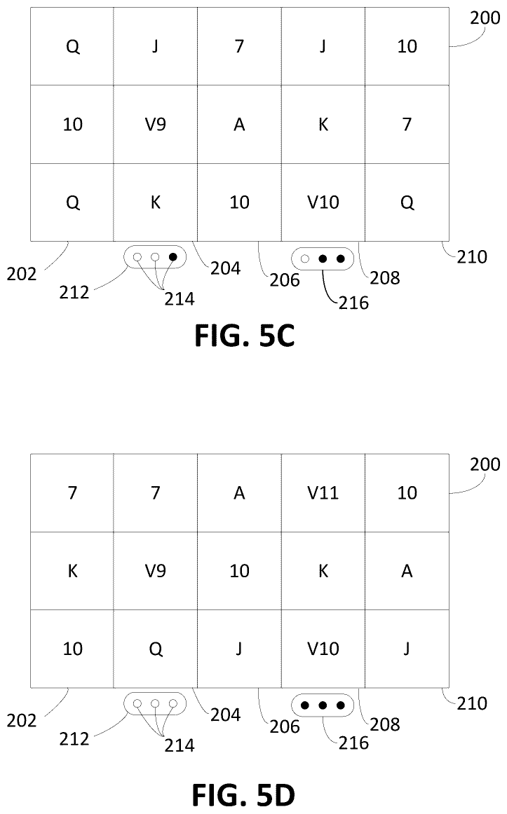

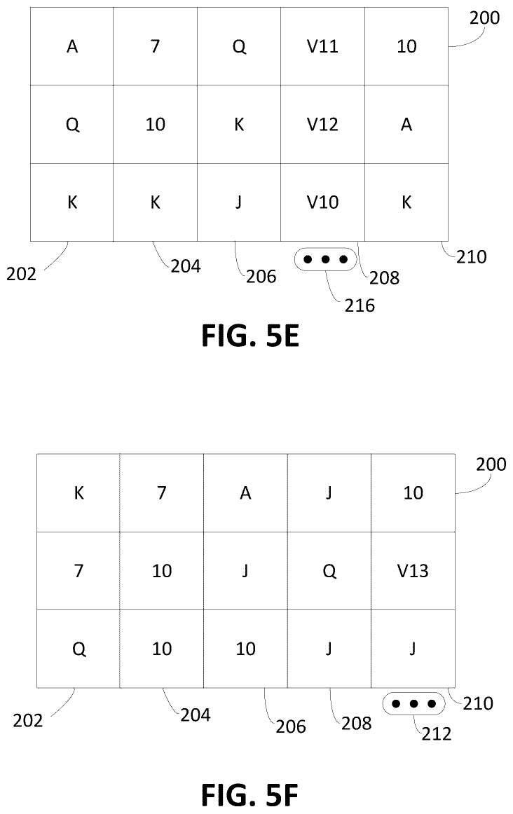

FIGS. 5A-5F depict an example game interface during play of a game implementing the game feature described in FIG. 4. More specifically, FIG. 5A depicts the interface at a first game cycle outcome, FIG. 5B depicts the interface at a second game cycle outcome, FIG. 5C depicts the interface at a third game cycle outcome, FIG. 5D depicts the interface at a fourth game cycle outcome, FIG. 5E depicts the interface at a fifth game cycle outcome, and FIG. 5F depicts the interface at a sixth game cycle outcome. The game cycles are ordered in chronological order such that the first game cycle precedes the second game cycle, which precedes the third game cycle, and so forth.

In each game cycle, a plurality of symbol-bearing reels is spun and stopped to land a plurality of symbols in a symbol array 200. The illustrated array 200 has fifteen symbol positions arranged in three rows and five columns 202, 204, 206, 208, and 210. Each column is associated with a respective reel such that each stopped reel presents three symbols. Alternatively, each symbol position may be associated with a respective independent reel such that each stopped reel presents a single symbol. The array may have more or less rows and/or columns. The number of symbol positions in each column may vary from each other. For example, the number of symbol positions in each column may be progressively increased such that the first column 202 has less symbol positions than the fifth column 210 does.

In the example embodiment, the subsets described in FIG. 4 are the columns 202, 204, 206, 208, and 210 of the symbol array 200. It is to be understood that the subsets may be defined alternatively as rows or other suitable combinations of symbol positions (including combinations that are not adjacent to each other). In certain embodiments, some of the symbol positions of the array 200 are not associated with any subset. For example, the first column 202 may not be a subset, and therefore value-bearing symbols either are not present within the reels of the first column 202 or are not locked to the first column to determine an award as described herein.

Referring to the first game cycle of FIG. 5A, the reels are spun and stopped to land a plurality of symbols in the array 200. As shown in FIG. 5A, the landed plurality of symbols includes a value-bearing symbol V9 in the second column 204. Similar to the value-bearing symbols described above, the value-bearing symbol V9 includes visual value indicia (e.g., a value presented in text) indicating a value associated with the value-bearing symbol V9. The value of the value-bearing symbol V9 and other value-bearing symbols may be predefined, fixed values or dynamic values. For dynamic values, the value of each value-bearing symbol may be randomly determined and/or a function of one or more value parameters. The value parameters may include, but are not limited to, a wager amount, wager frequency, wager history, game history, player history, and/or other suitable parameters associated with the player and/or the game. In one example, as a player wagers more on each game cycle or spin, the potential value of the value-bearing symbols may increase. In certain embodiments, the identity of the particular column or subset may be a value parameter. For example, the second column 202 may include a lower average value for each value-bearing symbol relative to the average value of value-bearing symbols within the fifth column 210. In certain embodiments, the value-bearing symbols are not limited to a value amount but may include value indicia indicating one or more progressive jackpots associated with the wagering game. That is, the value of the progressive jackpot may be awarded from a value-bearing symbol if the award conditions described herein at met.

In response to the value-bearing symbol V9 landing in the second column 204, a subset counter 212 is initialized for the second column 204. In the example interface, none of the other columns have active subset counters, and the difference between active and inactive subset counters is visually denoted by the inactive subset counters between removed from the interface. However, in other embodiments, other suitable visual characters may be used to distinguish between active and inactive counters. For example, inactive counters may be greyed-out. The subset counter 212 may undergo a transition animation to depict the change from the inactive state to active. Such a transition animation may include other elements of the interface, such as the value-bearing symbol V9 and/or the column 204.

The subset counter 212 is initialized at an initial count of three. The counter 212 is configured to count game cycle outcomes and establishes a finite window for the player to achieve the award conditions associated with the second column 204. The counter 212 includes a plurality of count indicators 214 that visually indicate the current count of the counter 212. In the example embodiment, the count indicators 214 are a series of dots in which filled-in dots represent the current count (which is three in FIG. 5A). Not only do these dots indicate the current count, but also how the current count relates to the termination count and the initial count. In other embodiments, other suitable indicators of the current count may be used, such as a text-based indicator.

The value-bearing symbol V9 is locked into the symbol array 200 such that, for one or more subsequent game cycles, the value-bearing symbol V9 occupies a symbol position irrespective of the underlying reels. That is, the locked value-bearing symbol V9 may supersede an underlying symbol from the reels in the same position, or the reels may ignore or skip the symbol position. The value-bearing symbols may be locked into the symbol positions in which the value-bearing symbols landed in or other symbol positions within the symbol array 200. For example, the value-bearing symbol V9 may be locked to the second column 204 such that the value-bearing symbol V9 may be moved to a different position within the second column 204. This may be beneficial particularly in embodiments in which paylines and/or other features of the game may need certain rows or symbol positions unoccupied by value-bearing symbols to activate. The locking process may include one or more animations to indicate to the player that the value-bearing symbol has been locked. For example, a border or background may be added to the symbol position of the locked value-bearing symbol V9 to visually distinguish the locked symbol position from other symbol positions. In another example, one or more visual characteristics (including any animation) of the value-bearing symbol V9 may be changed to indicate that the value-bearing symbol V9 has been locked.

With respect now to FIG. 5B, the second game cycle has been initiated to generate an outcome, and the symbol array 200 has been populated by a new set of symbols with the exception of the locked value-bearing symbol V9. In the second game cycle outcome, no additional value-bearing symbols have been detected in the second column 204. As a result, the subset counter 212 is decremented by one, and the count indicator 214 has been updated to indicate that the current count is two. In other embodiments, different adjustments may be made to the current count of the subset counter 212 in response to no additional value-bearing symbols being detected in the second column 204. For example, the initial count of the counter 212 may be zero or one, and the count is incremented instead of decremented. In another example, the counter 212 may be set at a value or count rather than applying arithmetic operations. The operations applied to the counter 212 may be linear (e.g., decrementing by one for each cycle without additional value-bearing symbols) or non-linear. Non-linear operations may be used, for example, in embodiments in which the count of the counter 212 is used to generate visual elements or animations like a graph for the indicator 214 or in embodiments in which the current count may have a functional relationship to one or more elements of the game, such as the value of the next value-bearing symbol.

In addition to the updated count of the counter 212, the fourth column 208 includes a value-bearing symbol V10 in the second game cycle outcome. The value-bearing symbol V10 is locked to the fourth column 208, and a subset counter 216 associated with the fourth column 208 has been initialized similar to the subset counter 212 in the first game cycle outcome shown in FIG. 5A. As described herein, with respect to the value-bearing symbol feature, each column may be independent of the other columns. That is, the counter and award conditions are independent for each column. In other embodiments, value-bearing symbols, counters, and/or award conditions may be affected by the state of symbol positions of the array 200 outside of the associated column. For example, receiving an award for value-bearing symbols in one column may remove or unlock the value-bearing symbols in other columns.

FIG. 5C depicts the interface in response to an outcome being generated for the third game cycle. In the illustrated example, no additional value-bearing symbols landed in the symbol array 200. As a result, the subset counters 212, 216 have been decremented to one and two, respectively. The respective count indicators 214 have been updated to visually indicate these adjustments to the counters 212, 216 to the player.

Following the third game cycle, FIG. 5D depicts the outcome of the fourth game cycle succeeding the third game cycle. In the fourth game cycle, no additional value-bearing symbols have landed in the second column 204, thereby failing to achieve the award conditions within the period of time defined by the subset counter 212. As a result, the subset counter 212 has been decremented from one to zero. In the example embodiment, zero is the termination count for the counters. When the termination count is met by the counter 212, the value-bearing symbol feature is reset for the column 204. More specifically, the value-bearing symbol V9 is removed from the symbol array 200 and the counter 212 is also deactivated as described further in detail below with respect to FIG. 5E. It is to be understood that, in this context, ‘removing’ the value-bearing symbol V9 may include the removal of the value-bearing symbol prior to the next spin or game cycle or unlocking the value-bearing symbol V9 such that the symbol position is available to receive a new symbol from the next spin. The value(s) of the removed value-bearing symbols from the second column 204 are not awarded in the example embodiment. In other embodiments, other suitable game features may facilitate retrieval of at least a portion of the aggregated value of the removed value-bearing symbols.

The fourth game cycle outcome also includes a new value-bearing symbol V11 in the fourth column 208. The value-bearing symbol V11 is locked into the fourth column 208 and the subset counter 216 is reset to three (i.e., the initial count) as shown by the counter indicators 214 of the counter 216. That is, in the example embodiment, the current count of an active subset counter is reset to three in response to one or more additional value-bearing symbols irrespective of whether the current count is one, two, or three. In other embodiments, the current count is incremented or remains the same rather than reset to the initial count or another predefined value. It is to be understood that different configurations of the counters (i.e., different initial counts, termination counts, and/or operations) may result in different specific operations applied to the current count of the subset counters. The general configuration of the example counters is that landing new value-bearing symbols causes the current count to move towards or to the initial count and away from the termination count, and vice versa for not landing any new value-bearing symbols. This general configuration incorporates ‘streak’ gameplay in which continually accruing positive outcomes (i.e., a “hot streak”) extend play of the game feature, while repeated misses (i.e., a “cold streak”) causes the game feature to end. In other embodiments, other suitable configurations of the counters may be used to regulate play of the game feature.

The fifth game cycle follows immediately after the fourth game cycle, and FIG. 5E depicts the outcome of the fifth game cycle. As described with respect to FIG. 5D, the second column 204 did not achieve the award conditions of filling every symbol position in the column 204. As a result, the value-bearing symbol V9 was removed or unlocked from the symbol array 200 and the symbol position is populated with a new symbol (which may be another value-bearing symbol). The subset counter 212 shown in FIGS. 5A-5D has been returned to an inactive state similar to the counters of the first, third, and fifth columns 202, 206, 210. In the example embodiment, the subset counter 216 of the fourth column 208 is not affected by the subset counter 212 returning to the inactive state. The inactive state of the counter 212 may persist at least until one or more triggering conditions (e.g., a new value-bearing symbol in the second column 204) are detected in subsequent game cycles.

In the fourth column 208, an additional value-bearing symbol V12 has landed, thereby filling every symbol position in the column 208 with a value-bearing symbol. In the example embodiment, the award conditions have been met for the fourth column 208, and an award is provided. More specifically, the values indicated by the value indicia of the value-bearing symbols V10, V11, and V12 are combined together as an aggregated award value. In some embodiments, if one or more of the value-bearing symbols includes a progressive jackpot indicia, the jackpot value may be combined with the other awarded values.

In addition to providing an aggregated award value, the value-bearing symbols V10, V11, and V12 are removed or unlocked from the fourth column 208 for the next game cycle, and the subset counter 216 is set to an inactive state. This process is similar to the steps taken in response to a counter meeting the termination count. The difference between the two processes, in the example embodiment, being whether or not the values of the value-bearing symbols are awarded.

FIG. 5F depicts the outcome of the sixth game cycle following the fifth game cycle. The fourth column 208 has been reset as described above to await a new value-bearing symbol to activate the counter 216 (shown in FIGS. 5B-5E) again. The fifth column 210 includes a new value-bearing symbol V13, and an associated subset counter 218 is activated similar to the subset counter 212 in FIG. 5A and the subset counter 216 in FIG. 5B. Although only one or two subset counters have been active at a time in FIGS. 5A-5F, it is to be understood that any other suitable number of columns (including none and all of the columns) may have an active associated column timer on a given game cycle. In certain embodiments, a limitation may be placed on the number of columns having an active column timer on a given game cycle.

In at least some embodiments, the gaming system is configured to provide an intermediate presentation that hides or otherwise obscures one or more award values that are awarded in response to meeting or exceeding the threshold number of trigger symbols before revealing the full or total award values, thereby creating additional anticipation and excitement prior to the award sequence. In one example, one or more value-bearing symbols are selected to be presented with a partial award value until the symbol is to be awarded. In another example, the value-bearing symbols include indicia indicating a plurality of award values, and one award value of the plurality of award values is selected to be awarded. In yet another example, the indicia of a symbol is hidden until a corresponding award sequence is presented. In a further example, in response to meeting the award condition for a subset with a hidden value symbol causes a scripted or predetermined bonus game or bonus game outcome to occur to provide the full award value. Other suitable configurations with intermediate obscured presentations may be used, including those described elsewhere herein.

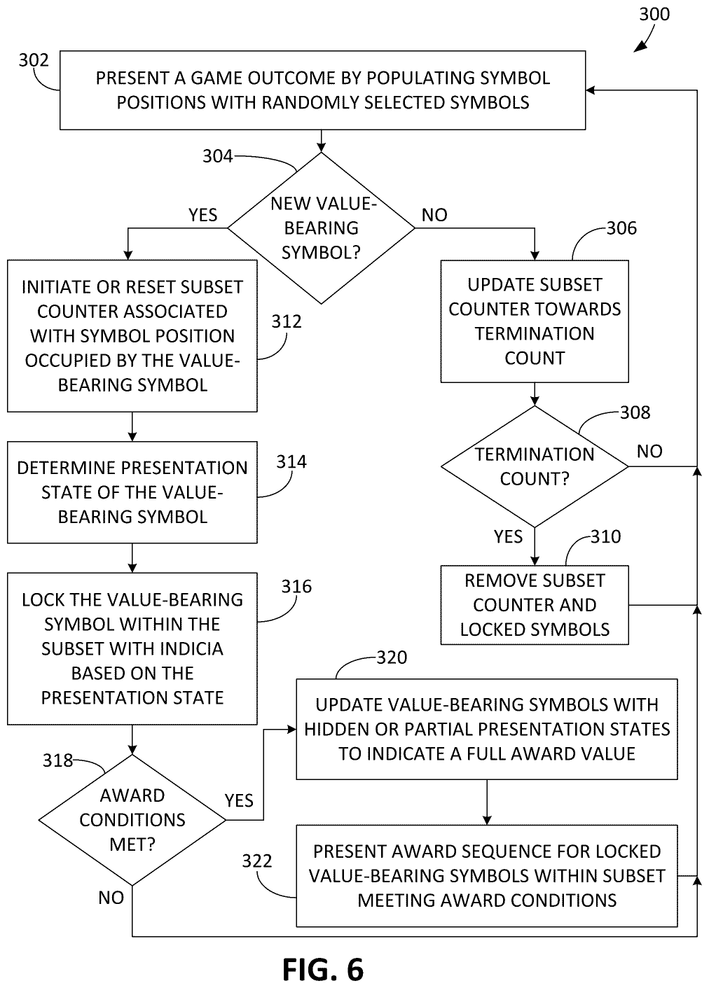

FIG. 6 is a flow diagram of an example method 300 for operating a gaming machine of a gaming system (e.g., the system and machine 10 of FIGS. 1 and 2) according to one or more concepts of the present disclosure. The method 300 is associated with a game provided by the gaming machine, and the method 300 is in relation to game functionality of the game. The game may include other functionality beyond the steps described with respect to the method 300. The method 300 is similar to the method 100 shown in FIG. 4 (and, by extension, associated with game functionality similar to the game functionality associated with the method 100) unless otherwise as described herein. In particular, the method 300 provides an intermediate process for obscuring or hiding a ‘true’ or full value of one or more value-bearing symbols and revealing this full value prior to providing an award associated with the value-bearing symbol(s), thereby facilitating a unique anticipatory presentation sequence for the underlying game.

The method 300 is performed by game-logic circuitry in communication with a presentation assembly of the gaming machine to facilitate the visual and/or other suitable presentation outputs associated with the game functionality described herein. The game-logic circuitry may be at least partially integrated with the gaming machine or within an external device (e.g., a gaming server) in communication with the gaming machine. In some embodiments, a portion of the functionality of the game-logic circuitry is performed by a device external to the gaming machine while another portion is performed by game-logic circuitry within the gaming machine. In other embodiments, the method 300 is performed by a different configuration of devices and/or includes additional, fewer, or alternative steps, including those described elsewhere herein. For example, at least some steps from the method 100 are omitted from the illustrated method 300 shown in FIG. 6 but may still be performed to facilitate the underlying game and/or the steps of the method 300 described herein.

The method 300 begins within a gaming session of a game hosted or provided by the gaming machine. That is, prior to the steps of the method 300, a player has initiated the gaming session for play of the game. For embodiments with a wagering game, initiating the gaming session may include establishing a credit balance to fund wagers and receive awards during play of the game. For non-wager game embodiments, another suitable balance may be established (e.g., a timer, a number of non-monetary credits, a number of attempts, etc.) or via simple player input without a balance (i.e., free play).

The game associated with the method 300 may be one game feature of a plurality of game features forming a singular game. That is, the method 300 may be associated with a base game feature or a bonus game feature that is initiated in response to one or more game events and/or conditions detected within a base game feature. In the example embodiment, the method 300 is associated with a base game feature.

The presentation assembly of the gaming machine is configured to present a game interface for presenting various game and/or presentation elements that provide a visual depiction of the underlying game functionality described herein and any other suitable game functionality for a give game configuration and theme. In the example embodiment, the game interface includes a plurality of symbol positions that are selectively occupied by symbols randomly selected from one or more sets of available symbols. The sets of available symbols may be symbol-bearing reel strips, which are animated to spin and stop to show symbols within an associated one or more symbol positions. In at least some embodiments, the symbol positions are arranged into a symbol array, where the symbol array includes rows and columns of symbol positions. The symbol positions are organized into a plurality of position subsets for the functionality described herein. In one example, each column of the symbol array is a respective position subset. In another example, symbol positions are visually divided into position subsets by a shared background color or watermark presented within each position. In certain embodiments, each symbol position may be more than one position subset and/or some symbol positions may not be in any position subset. That is, the symbol positions outside of the position subsets may not be eligible for the game functions described herein with respect to the method 300. The game interface may include additional or alternative game elements for the game outcome, which may be incorporated into the game functions described herein or provide additional game functionality.

In the example embodiment, the game interface selectively includes a counter for each subset referred to herein as a ‘subset counter’ for monitoring a limited duration set of game events for the subset similar to the method 100 shown in FIG. 4. In some embodiments, a single counter may be used for all of the subsets. The subset counter may be selectively presented in response to an initial trigger event associated with the subset counter (e.g., detecting a trigger symbol within the subset) or visually transition from an inactive state to an active state until the initial trigger event is detected. Likewise, the subset counter may be removed from the game interface or transitioned back to the inactive state in response to the subset counter meeting a termination count (which may be the same or different for each subset). In other embodiments, the subset counters may not be presented within the game interface. Rather, in such embodiments, the current count of each active subset counter may be monitored via underlying variables stored by the game-logic circuitry and/or other suitable presentation elements and/or animations within the game interface. For example, if the game interface includes a flame border around a given subset, the flames may change to have a relative increased intensity the closer the current count is to the termination count.

The method 300 begins at step 302 with the game-logic circuitry generating a game outcome and the presentation assembly presenting the game outcome via an outcome sequence. More specifically, the game-logic circuitry randomly selects symbols to occupy the symbol positions from the one or more sets of available symbols. The random selection by the game-logic circuitry may be weighted to adjust the probability of selecting certain symbols over other symbols. The outcome sequence presented by the presentation assembly includes one or more animations, visual updates, and/or other suitable presentation outputs that visually convey to the player that a new game outcome has been determined. In one example, symbol-bearing reel strips are animated to spin and stop at the symbols selected for the game outcome. It is to be understood that populating the symbol positions with symbols may include some or all of the positions being occupied by a blank (i.e., no symbol occupying the position).

In response to generating the game outcome, the game-logic circuitry is configured to perform one or more outcome determinations. That is, the game-logic circuitry analyzes the symbols and/or other game elements forming the game outcome against stored, predefined logic and parameters to determine the presence or absence of certain game events. Steps 304, 308, and 318 depict several example outcome determinations as described herein. Other suitable outcome determinations may be performed by the game-logic circuitry, such as detecting any winning symbol combinations, jackpot trigger events, bonus trigger events, and the like. The outcome determinations may be performed serially and/or in parallel. Some outcome determinations (such as the step 304 with steps 308 and 318, respectively) may be performed according to a particular order to facilitate a particular game configuration, while other outcome determinations may be performed irrespective of other determinations. Such independent outcome determinations may be performed according to an execution order or according to the resource availability of the game-logic circuitry.

In the example embodiment, the steps 304-322 are performed for each subset. That is, the method 300 is performed independently on a per subset basis, thereby isolating detected symbols and game events to each subset. For example, and as explained in detail below, a subset counter may be reset for one subset while an award sequence is initiated for another subset irrespective of the first subset. Accordingly, although the method 300 is sometimes described herein with respect to a single position subset, it is to be understood that the steps are repeat for any remaining subsets.

At the step 304, the game-logic circuitry determines whether or not the game outcome includes any new value-bearing symbols within the position subset. Each value-bearing symbol is associated with a respective award value. Although the following steps are described with respect to detecting any value-bearing symbols, it is to be understood that similar steps may be performed with other trigger symbols (e.g., non-value-bearing symbols, modifier symbols, etc.) associated with the functionality described herein. For example, the initiation, updating, and removal of subset counters and/or award conditions for the subset may be responsive to other trigger symbols in addition to any value-bearing symbols. In such embodiments, in response to trigger symbols other than value-bearing trigger symbols, the game-logic circuitry and the presentation assembly may be configured to perform a portion of the steps of the method 300 while bypassing the steps directed to award indicia of the value-bearing symbol. In certain embodiments, the non-value-bearing trigger symbols may include similar functionality as the hidden presentation states described herein with respect to value-bearing symbols, and such presentations may be adapted to the particular functionality and/or value of the non-value-bearing trigger symbols.

If no new value-bearing symbols are detected at step 304, the method 300 proceeds to step 306 if the subset counter is active. More specifically, the game-logic circuitry updates the subset counter towards a termination count and the presentation assembly updates the counter to visually reflect the new current count. The update to the subset counter may include, for example, incrementing or decrementing the current count. In some embodiments, the lack of new value-bearing symbols may not cause the subset counter to be updated, but rather another suitable game event or condition is monitored, and the subset counters are updated in response to detecting the presence or absence of said game event. In at least some embodiments, if there is no active subset counter for the subset, the steps 306-310 may be skipped, and the game-logic circuitry performs any remaining outcome determinations before initiating a subsequent game outcome at step 302, which may be initiated in response to the player providing a wager for the subsequent game outcome.

At step 308, in response to updating the current count of the subset counter, the game-logic circuitry determines whether or not the current count has reached or exceeded the termination count. The game-logic circuitry stores one or more variables representing the termination count and compares the stored variable(s) to the one or more variables representing the current count. Based on the comparison, if the termination count is not met, the subset count remains active, and the game-logic circuitry proceeds to any remaining outcome determinations before the next game outcome at step 302. If, however, the termination count has been met or exceeded, the method 300 proceeds to step 310. At step 310, the game-logic circuitry causes the presentation assembly to remove the subset counter (or transition the subset counter to an inactive state) and removes any locked symbols within the subset similar to the method 100, including the value-bearing symbol as described herein with respect to steps 312-322. After the symbols and counter are removed, the game-logic circuitry completes any remaining outcome determinations and proceeds to the next game outcome, which may include one or more new trigger symbols within the subset to proceed with the other steps 312-322.

Returning to the determination at step 304, if a value-bearing symbol is detected in the subset, the method 300 proceeds to step 312. More specifically, at step 312, the game-logic circuitry causes the presentation assembly to initiate a subset counter for the subset or otherwise reset the counter if the counter was previously active. The initial count and the reset count may be the same or different, and either count may be a static, predefined value or a dynamic value based on one or more detected parameters. In one example, the initial count may be based on a wager amount and/or frequency of the player. In another example, the reset count is either the initial count or a checkpoint count depending upon the current count at the determination of the step 304. In certain embodiments, the subset counter does not include a reset condition or an alternative reset condition. For example, a dedicated reset symbol may selectively populate the position subset, and detecting said reset symbol causes the subset counter to be reset.

At step 314, prior to presenting the value-bearing symbol (or, at least award indicia of the symbol), the game-logic circuitry is configured to determine a presentation state of the value-bearing symbol. That is, the value-bearing symbol may be presentable in a plurality of different presentation states, and the game-logic circuitry may select one of the presentation states to initially present the value-bearing symbol. In the example embodiment, the presentation states include at least a full presentation state and a hidden presentation state. The full and hidden presentation states influenced the presentation of the award indicia of the value-bearing symbol, particularly in relation to the actual award value associated with the value-bearing symbol.

The determination of the presentation state may be at least partially random, based on current game parameters, and/or a symbol type of the value-bearing symbol. In one example, the game-logic circuitry generates one or more random values via the random number generator and compares the random values to one or more weights, values, and/or other suitable parameters to determine which presentation state is to be selected for a given value-bearing symbol. In another example, the value-bearing symbol may be a type of value-bearing symbol in which the award indicia is to be revealed through subsequent game events as described herein.

At step 316, the presentation assembly locks the value-bearing symbol in the position subset with indicia based on the selected presentation state. For the full presentation state, the award indicia is presented to match the full award value associated with the value-bearing symbol (such as the presentation state shown for the value-bearing symbols in FIGS. 5A-5F). For the hidden presentation state, the award indicia is either hidden, presents a partial award, or otherwise obscures the relationship between the value-bearing symbol and the true, full award value associated with the symbol. In one example, the full award value is presented amongst a plurality of other award values (e.g., as a value-bearing reel strip, an award wheel, etc.) within the value-bearing symbol in the hidden presentation state such that the player cannot readily identify the full award value as the one value associated with the value-bearing symbol.

Although the hidden presentation state causes the value-bearing symbol to be presented without revealing the full award value, the underlying value of the symbol is still the full award value. If, for example, the value-bearing symbol in the hidden presentation state were to be modified by a multiplier, the multiplier is still applied to the full award value rather than the value shown by the award indicia.

At step 318, the game-logic circuitry determines whether or not award conditions have been met for the position subset. In particular, the game-logic circuitry determines whether or not the number of locked trigger symbols (including the value-bearing symbol) have met or exceeded a trigger threshold representing an award condition. In one example, the trigger threshold is equal to the number of symbol positions in a given subset (i.e., filling a subset causes an award). In another example, the trigger threshold is less than the number of symbol positions in a given subset. In other embodiments, additional or alternative award conditions may be considered to determine whether or not an award is to be provided for the position subset.

If the game-logic circuitry determines the award conditions have not been met, the game-logic circuitry completes any remaining outcome determinations prior to the next game outcome. If, however, the award conditions have been determined to have been met, the method 300 proceeds to steps 320 and 322. Steps 320 and 322 are associated with presenting an award sequence with the presentation assembly, which includes animations, visual updates, and/or other presentation outputs to the player to indicate, at least visually, that an awarding game event has occurred and the corresponding award.

Prior to presenting a total or aggregate award for the position subset, the game-logic circuitry causes the presentation assembly to update any locked value-bearing symbols in the hidden presentation state to the full presentation state, thereby causing the value-bearing symbols to include award indicia visually indicating the respective full award values. In some embodiments, the transition to the full presentation state is not limited to changes to the award indicia, but rather other animations and/or game events occur to visually indicate the change in presentation state. In one example, an award wheel, prize board, or other value-bearing game element is activated to present the full award value, either as a whole or through incremental game events totaling to the full award value. In another example, one or more scripted game events may be used within the game outcomes to organically increase the value-bearing symbol in the hidden presentation state to the full presentation state. For example, detecting the award condition may cause a bonus game feature or a free game outcome to be presented with one or more game events that cause the hidden presentation state symbols to appear to be enhanced to the full presentation state. Such scripted game events may be applied by the game-logic circuitry to game outcomes in such a manner that does not negatively affect game events occurring through the random symbol selection at the step 302.

The determination at step 314 and the presentation at step 316 for each value-bearing symbol detected during the game outcomes causes various value-bearing symbols to be presented in different presentation states. As a result, the transition to the full presentation state at step 320 may occur for all, some, or none of the value-bearing symbols locked in the position subset. The reveal of the full award values provides a unique anticipatory presentation sequence without complex rules that may otherwise provide a burden to computing resources of the gaming machine.

In some embodiments, the hidden and full presentation states are indistinguishable from each other to the player, particularly embodiments in which a partial value is shown. Accordingly, the reveal at the step 320 then occurs without providing the player prior knowledge of which value-bearing symbols have a hidden award value. In other embodiments, the hidden and full presentation states are visually distinguished from one another prior to the step 320. In one example, the value-bearing symbols in the hidden and full presentation states appear as different symbols at least until the hidden presentation state value-bearing symbols are updated to include award indicia reflecting the respective full award value.

In certain embodiments, rather than updating the award indicia of the value-bearing symbols in the hidden presentation state, the full award values may be revealed via other suitable presentation elements within the game interface. In one example, a meter (e.g., an award or credit meter) may be updated to include the additional award value not shown by the award indicia of a value-bearing symbol in the hidden presentation state, thereby ensuring that the player still receives the full award value without updating the value-bearing symbol itself.

With all of the locked value-bearing symbols now in the fully presentation state, the presentation assembly continues the award sequence at step 322 to provide an award at least partially as a function of the value-bearing symbols in the position subset. Any non-value-bearing trigger symbols may affect the provided award as well, such as applying modifiers, values from a look-up table associated with different symbols, and the like to the award value. In the example embodiment, the provided award is an aggregate award value from the value-bearing symbols in combination with any locked modifiers within the position subset. In certain embodiments, the award may include non-credit awards, such as free spins, wild symbols, modifiers, and the like. Presentation of the award sequence may include visual updates to one or more meters within the game interface. For example, a credit meter may be increased by the awarded value and/or an award meter may be updated to track the current and/or last award of the gaming session.

In the example embodiment, the award sequence includes removing the locked symbols from the position subset and removing the subset counter. In other embodiments, one or more symbols may remain and/or the subset counter may be reset or otherwise remain active following the award sequence. Following the award sequence, the game-logic circuitry completes any remaining outcome determinations before continuing to the next game outcome at step 302. In certain embodiments in which the method 300 is associated with a bonus game feature with a limited duration, the game-logic circuitry may determine whether or not to conclude the bonus game feature (e.g., compare the completed number of bonus game outcomes to a conclusion value) following the outcome determinations and prior to the next game outcome.

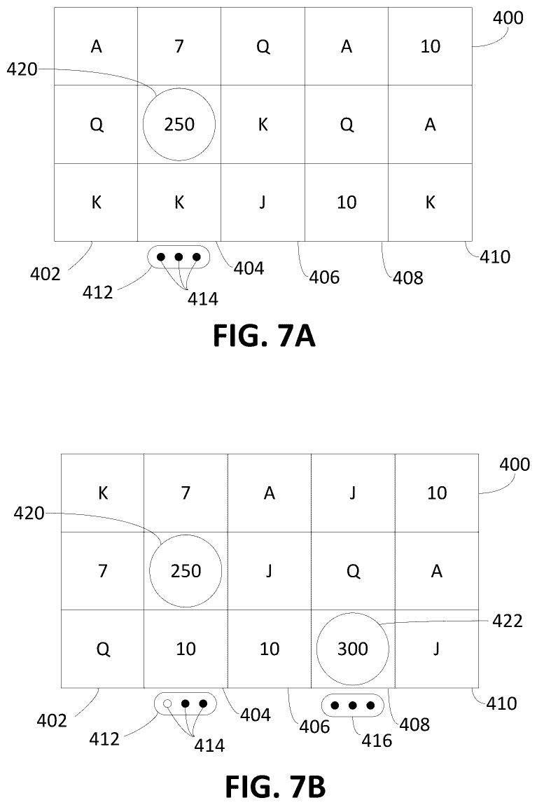

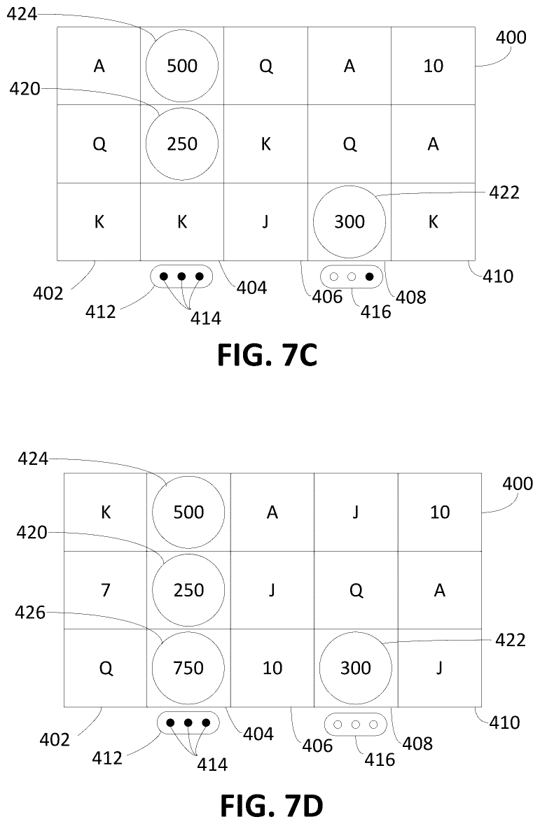

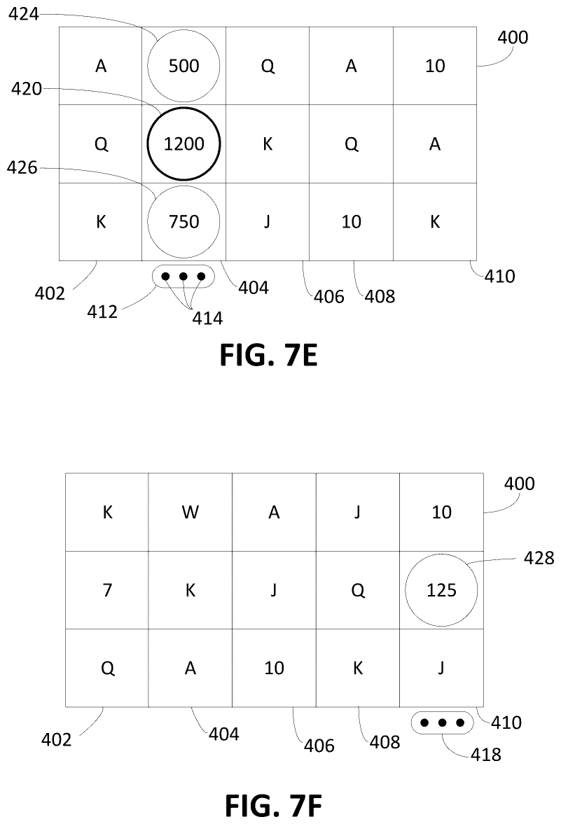

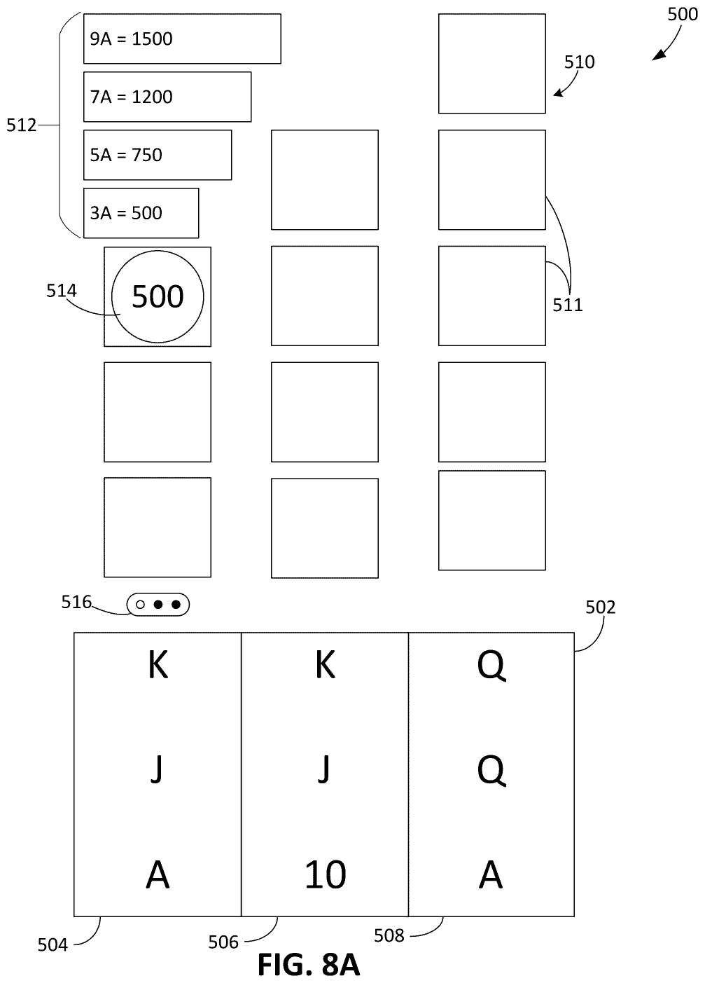

FIGS. 7A-7F depict an example game interface over a plurality of game states for a gaming system (e.g., the system shown in FIGS. 1 and 2). The game interface is presented via a presentation assembly of a gaming machine in communication with game-logic circuitry to provide at least the game functionality described herein. Although the game interface is shown in a manner that can be presented by a single display device, it is to be understood that the game interface may be divided across a plurality of presentation devices to facilitate the specific game and gaming machine configuration. In other embodiments, the game interface may include additional, fewer, or alternative game and/or presentation elements, including those described elsewhere herein.

FIG. 7A depicts the game interface in a first state. In the first state, the game interface includes a symbol array 400 of a plurality of symbol positions. The symbol positions are organized into five columns that each represent a separate position subset 402-410. In other embodiments, the symbol array 400 may include additional or fewer symbol positions and/or organize the symbol positions in a different configuration. In one example, the different columns may have a different number of symbol positions relative to each other. In certain embodiments, the game interface includes a plurality of symbol arrays 400. In other embodiments, the symbol array 400 includes additional, fewer, or alternative position subsets, which may include overlapping position subsets.

In the first state, the symbol array 400 is populated by a plurality of randomly selected symbols. The symbols include a value-bearing symbol 420 in the second position subset 405. The value-bearing symbol 420 is a trigger symbol, and a subset counter 412 is initiated for the second position subset 404 in response to the value-bearing symbol 420. The subset counter 412 includes three count indicators 414 to visually indicate that the counter 412 has a duration of three game outcomes as described herein. In other embodiments, the subset counter 412 visually indicates the remaining duration and/or current count of the counter 412 through other suitable means and/or has a different duration.

In the example embodiment, the value-bearing symbol 420 is determined by the game-logic circuitry based on one or more random values generated by a random number generator of the game-logic circuitry to be in a hidden presentation state. The hidden presentation state includes presenting the value-bearing symbol 420 with award indicia indicating a partial award value of the full award value associated with the value-bearing symbol 420. The partial award value may be a predetermined value, a random selection from one or more available partial values, at least partially a function of the full award value, and/or any other suitable mathematical and/or logical operations to define the partial value. In the illustrated embodiment, the award indicia of the value-bearing symbol 420 depicts a partial award value of ‘250’ for a full award value of ‘1200’ as shown herein. The value-bearing symbol 420 is locked into the second position subset 404 while the subset counter 412 is active.

FIG. 7B depicts the game interface in a second state following the first state. In the second state, a subsequent game outcome is presented. The subsequent game outcome includes the symbol array 400 occupied by a new set of randomly selected symbols with the locked value-bearing symbol 420. The new symbols include a new value-bearing symbol 422 in the fourth position subset 408, and therefore a new subset counter 416 is initiated for the fourth position subset 408. No new value-bearing symbols or other trigger symbols are presented in the second position subset 404, and the subset counter 412 is updated to decrement one subset indicator 414, thereby indicating the counter 412 has two remaining outcomes to achieve an award condition or detect a new trigger symbol for the second position subset 404.

The second value-bearing symbol 422 has been determined by the game-logic circuitry to be presented in the full presentation state. That is, in contrast to the first value-bearing symbol 420 including award indicia indicating a partial award value, the award indicia of the second value-bearing symbol 422 represents the full award value of the symbol 422 to function like the value-bearing symbols shown in FIGS. 5A-5F.

FIG. 7C depicts the game interface in a third state following the second state. The third state includes a game outcome that is several outcomes after the game outcome shown in FIG. 7B. In the third state, a new value-bearing symbol 424 is detected and locked into the second position subset 404, and no new trigger symbols have been detected in the fourth subset 408. The new value-bearing symbol 424, similar to the value-bearing symbol 422, is presented in the full presentation state such that the award indicia of the value-bearing symbol 424 indicates a full award value associated with the symbol 424.

The subset counters 412, 416 are updated in response to the presence or absence of trigger symbols in the corresponding subsets 404, 408, respectively. More specifically, the subset counter 412 is reset to three in response to the new value-bearing symbol 424, and the subset counter 416 has been reduced to one in response to the lack of new trigger symbols in the subset 408 the past two outcomes.

FIG. 7D depicts the game interface in a fourth state following the third state. The fourth state includes a subsequent game outcome with the symbol array 400 including another value-bearing symbol 426 in the second position subset 404 and, in response to the absence of any additional trigger symbols in the fourth position subset 408, an expired subset counter 416. The value-bearing symbol 426 and locked symbols 420, 424 have met a trigger or threshold number of locked trigger symbols for the second position subset 404 (e.g., filling the column or subset 404 with locked symbols), and an award sequence is initiated for the second position subset 404. In contrast, in response to the expired subset counter 416, a reset sequence is presented for the fourth position subset 408 to remove any locked symbols from the subset 408.

FIG. 7E depicts the game interface in a fifth state following the fourth state. In the fifth state, the award and reset sequences are being presented with the array 400 and associated symbols. That is, any locked symbols in the second position subset 404 that are in the hidden presentation state are animated or otherwise updated to reveal the full award value associated with each respective symbol, and the locked symbols (i.e., the value-bearing symbol 422) and counter of the fourth position subset 408 are removed from the interface without being awarded. Although the value-bearing symbol 422 was shown in the full presentation state, removing locked symbols that are in the hidden presentation state may include one or more animations or other visual updates that reveal, hint, or otherwise indicate the full award value and/or the hidden presentation state of the removed symbol. In other embodiments, the hidden presentation state symbols are removed without any indication to the player that the visually indicated value is anything other than the full award value. The fourth position subset 408 is reset to await any new trigger symbols from subsequent game outcomes that may initiate the subset counter 416 again.

For the second position subset 404, the value-bearing symbols 424, 426 are presented in the full presentation state, and therefore the award indicia of the value-bearing symbols 424, 426 remain the same (similar to the value-bearing symbols shown in FIGS. 5A-5F). However, the value-bearing symbol 420 is presented in the hidden presentation state, and the award sequence includes a sequence for transitioning the value-bearing symbol 420 to the full presentation state and/or otherwise revealing the full award value associated with the value-bearing symbol 420. In at least some embodiments, the award indicia of the value-bearing symbol 420 is visually updated to reflect the full award value (i.e., in FIG. 7E, the value indicia of the value-bearing symbol 420 has been updated by the presentation assembly from a value of ‘250’ to ‘1200’). The presentation assembly is configured to present one or more animations, visual updates, and the like to convey the full award value to the player. In some embodiments, the transition to the full presentation state may include scripted game events that increase the indicated award value of the value-bearing symbol up to the full award value.

In response to all of the locked symbols transitioning from the hidden presentation state, the award sequence continues with one or more animations and/or visual updates to the game interface that visually convey an award associated with the award sequence that is provided to the player. In the example embodiment, the award is an aggregate value of all of the value-bearing symbols within the second position subset 404 (and any modifiers associated with the locked trigger symbols). In other embodiments, the award may be generated or otherwise selected through other suitable mathematical and/or logical operations based on the locked symbols associated with the awarding subset (i.e., the second subset 404). In one example, a number of picks from a prize board or spins of an award wheel are determined based on the locked symbols of the awarding subset to generate a total award value. In another example, the award is equal to the highest value indicated by one of the locked value-bearing symbols in the awarding subset.

The award associated with the award sequence (which may be referred to as the “total award,” the “aggregate award,” or the “collected award”) is depicted through one or more visual updates, animations, and/or other presentation outputs. In at least some embodiments, the award is applied to one or more meters presented within the game interface, such as a credit meter and/or an award meter. The meters may include indicia or other suitable graphical elements that are animated to reflect the changes in response to underlying game events, such as the award sequence and the total award associated with said award sequence.

FIG. 7F depicts the game interface in a sixth state following the fifth state. In the sixth state, the award sequence of the fourth and fifth state has completed, and the symbol array 400 is populated with a new set of randomly selected symbols for a subsequent game outcome. The award sequence for the second position subset 404 concludes by removing the locked symbols from the array 400 and removing the subset counter 412 from the game interface. Accordingly, the second position subset 404 is ready to receive new trigger symbols to activate the subset counter 412 again.

The game outcome of the sixth state includes a new value-bearing symbol 428 occupying the fifth position subset 410, thereby initiating a corresponding subset counter 418. As can be seen by the different position subsets 402-410 through FIGS. 7A-7F, the position subsets, locked symbols, and counter operate independent of each other, thereby enabling the different subsets to be in different states relative the game functionality described herein. Play of the game continues through subsequent game outcomes until a termination condition is detected (e.g., lack of funds within the credit balance of the player or the player initiating a payout sequence). In some embodiments in which the game feature is a bonus game feature with a limited game duration, play of the game feature continues until the duration of the bonus game feature has expired, and the game is transitioned to a corresponding base game feature. In certain embodiments, the game may include a base game feature and a bonus game feature with the same or similar game functions, such as the functions described with respect to FIGS. 7A-7F, with the bonus game feature including one or more enhancements. In one example, the average value of the value-bearing symbols may be increased by changing the generation of the award values and/or providing additional high value symbols into the sets of available symbols. In another example, the subset counter may include an extended duration. In a further example, triggering the award sequence causes additional game events to occur, such as spinning an award wheel in addition to providing the total award for the locked symbols.

In some embodiments, the trigger symbols of the systems and methods described above and herein are not locked into the position subsets of the symbol array, but rather award groups are presented within the game interface to collect the trigger symbols (or other presentation elements representing the collected trigger symbols). It is to be understood that the term “award group,” although used herein in relation to embodiments in which the award groups are separate from the symbol array, may also include position subsets of the symbol array. That is, the position subsets of FIGS. 7A-7F are also award groups. In certain embodiments, an award group may include both symbol positions of the symbol array and positions external to the symbol array. In one example, the symbol array may be a subset of a cumulative symbol array formed by a plurality of active symbol positions (i.e., the symbol array) and selectively one or more inactive symbol positions that may be used within award groups for collecting trigger symbols.

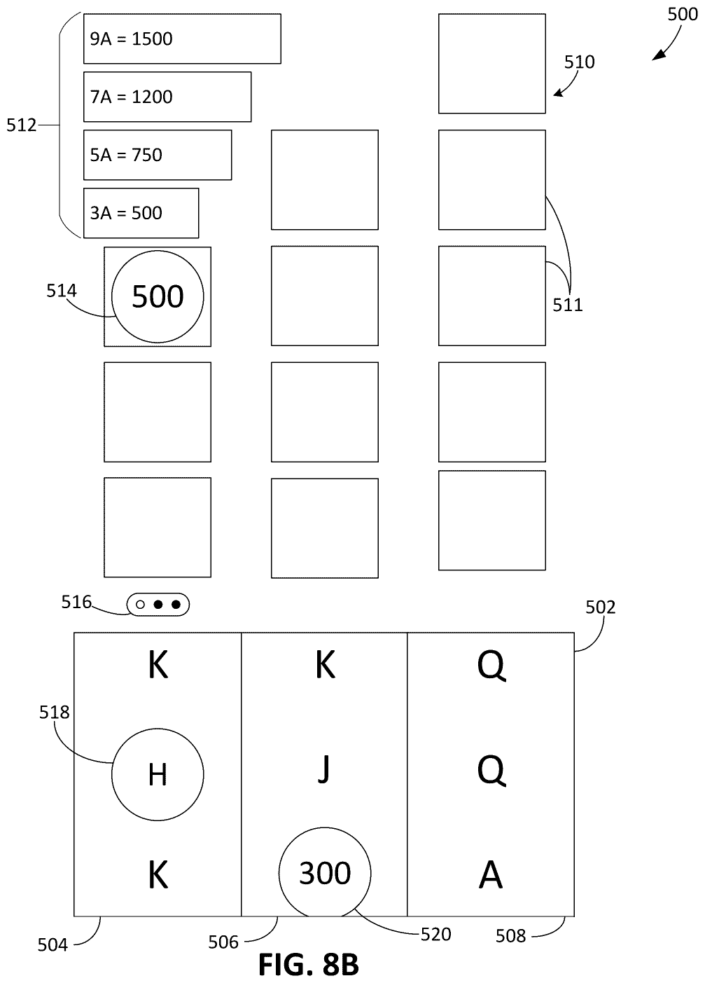

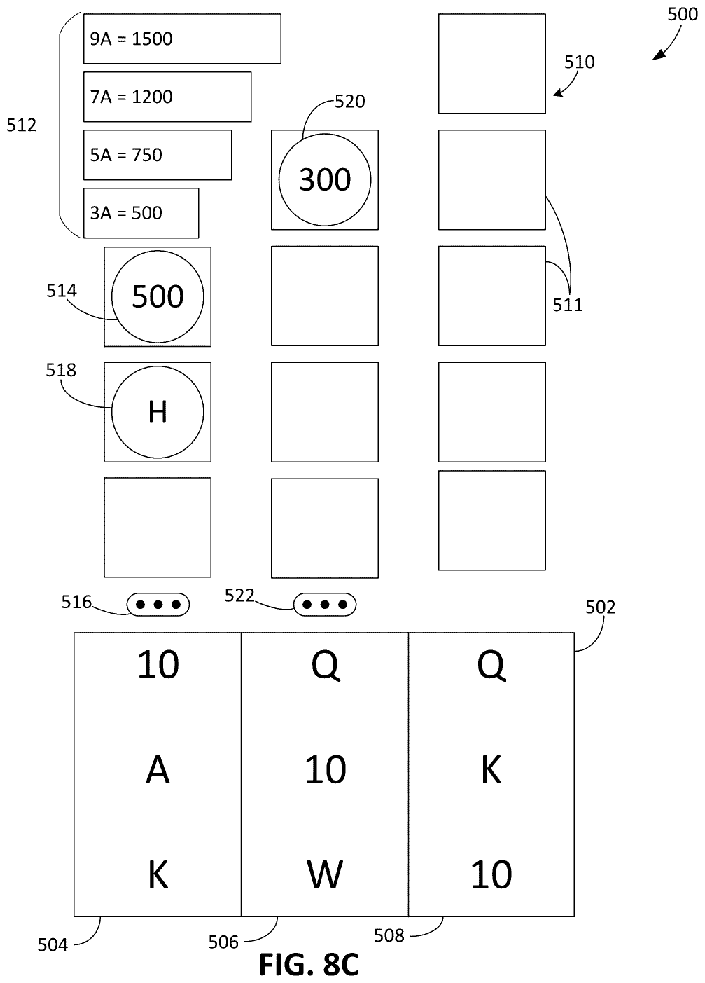

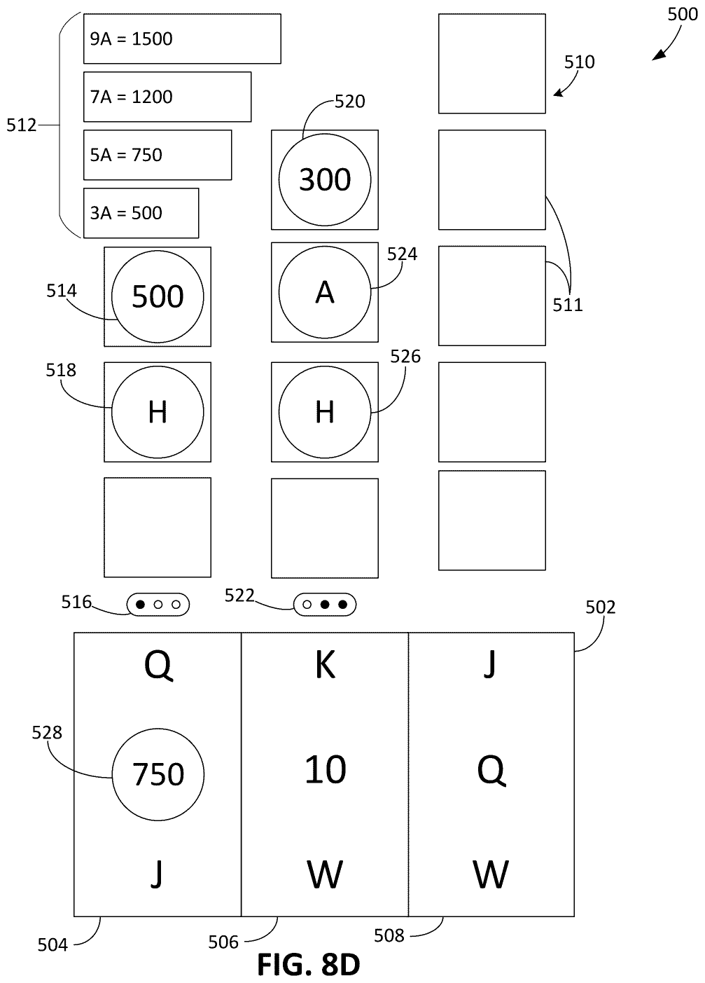

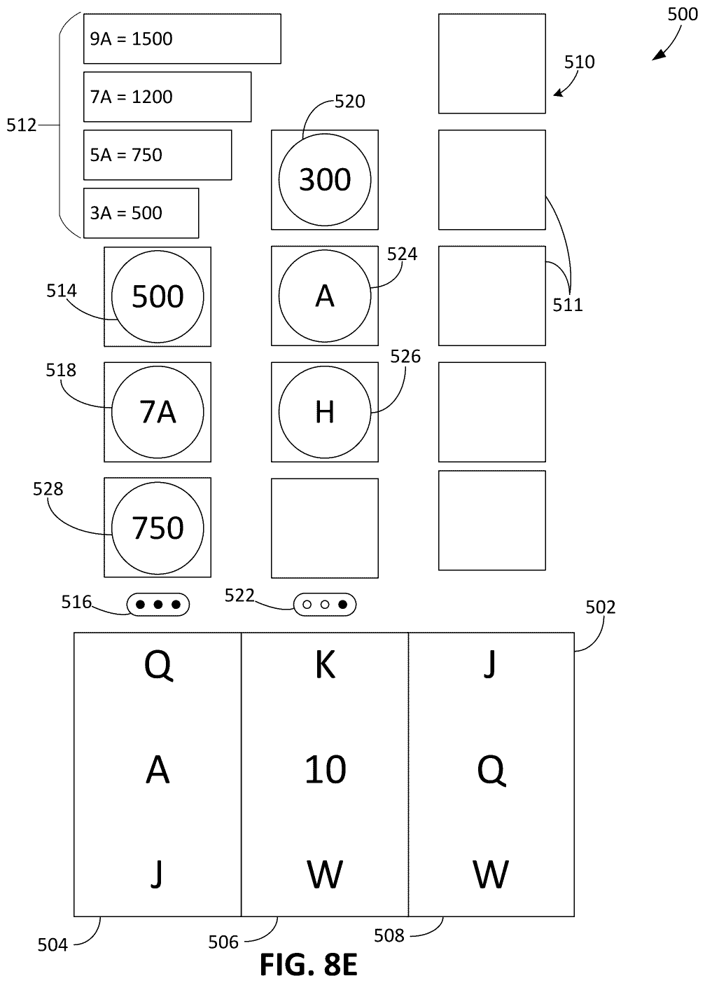

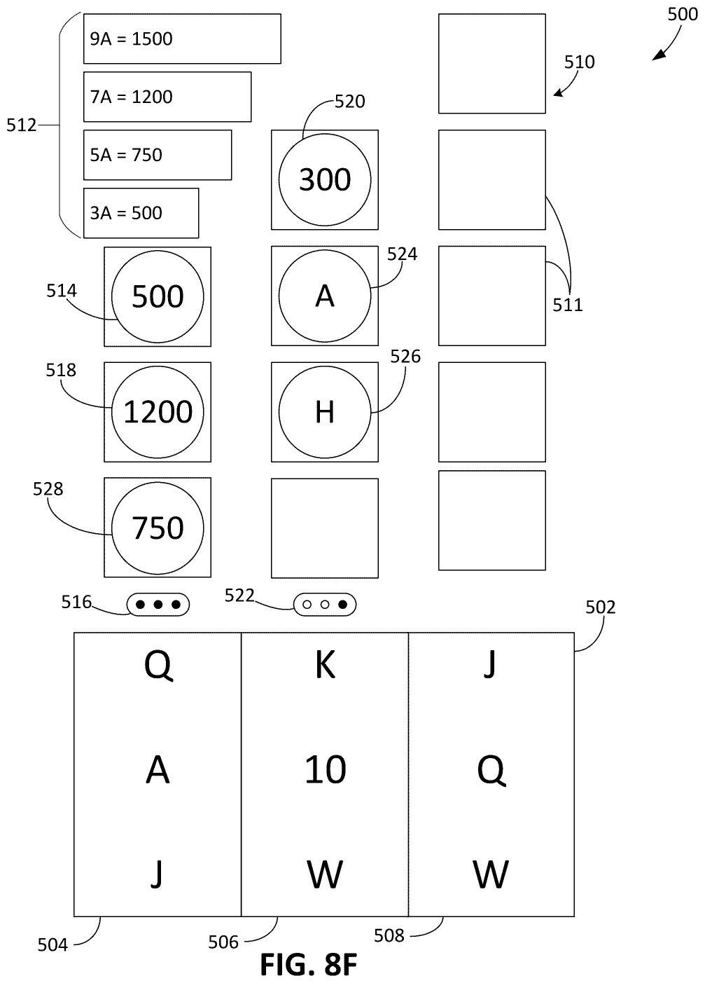

FIGS. 8A-8F depict an example game interface 500 presented by a presentation assembly of a gaming machine (e.g., the gaming machine 10 shown in FIGS. 1 and 2) through a plurality of states. The presentation assembly is in communication with game-logic circuitry of a gaming system including the gaming machine to provide the game and presentation functionality described herein. The game interface 500 includes a symbol array 502 formed of three columns or position subsets 504, 506, 508, three award groups 510 above the symbol array 502, and a plurality of award options 512. In other embodiments, the game interface 500 includes additional, fewer, or alternative game and/or presentation elements, including those described elsewhere herein. It is to be understood that the game interface 500 may be presented via a single presentation device of the presentation assembly or a plurality of presentation devices, which may include some mechanical presentation devices as described herein.

In the example embodiment, the symbol array 502 is associated with symbol-bearing reel strips for presenting randomly selected symbols for generating game outcomes. Each column 504, 506, 508 is associated with a respective reel strip. In some embodiments, the reel strips are mechanical reel strips that are at least partially viewable through the symbol array 502. In other embodiments, the reel strips are graphical elements and/or the reel strips are associated with a different configuration of the symbol positions, such as a single reel strip for each symbol position.

Each award group 510 is aligned with and associated with a respective position subset 504, 506, 508. In other embodiments, the award groups 510 and the position subsets 504, 506, 508 may not include a one-to-one relationship such that a single award group 510 may be associated with positions from more than one position subset 504, 506, 508, or vice versa. The award group 510 is presented with a plurality of award positions 511 that are selectively occupied by trigger symbols as described herein. In some embodiments, the award positions 511 may be used for other game functions (e.g., for selectively populating with symbols). In other embodiments, the award positions 511 are not presented as discrete presentation elements within the game interface 500, but rather are spaces occupied by locked trigger symbols as described herein.

In the example embodiment, each award group 510 includes a different number of award positions 511, and the award condition is filling the award group 510 with locked trigger symbols. Although the rightmost award group 510 requires more trigger symbols than the leftmost award group 510, the potential value of an achieved award condition provides a variety of exciting winning opportunities within the game feature. In some embodiments, the award conditions may include filling the less than the entire award group 510 with locked trigger symbols.

The plurality of award options 512 depict several available awards for collecting award symbols through the game outcomes. The award symbols are identified in the embodiments herein by indicia with an ‘A,’ and the number of award symbols collected within one or more game outcomes may cause the game-logic circuitry to provide a corresponding award from the plurality of award options 512. For example, collecting seven award symbols causes the game-logic circuitry to cause the presentation assembly to present an award sequence for the award corresponding to seven award symbols (i.e., an award of ‘1200’ credits). In other embodiments, the award options may include additional, fewer, or alternative available award options. In certain embodiments, the award options include progressive awards that may be funded through wagers provided to the gaming system (which may include other networked gaming machines).

With respect to FIG. 8A, the game interface 500 is shown in a first state. In the first state, a game outcome is depicted. The game outcome includes spinning and randomly stopping the reel strips to present symbols within the symbol array 502 and the game-logic circuitry performing one or more outcome determinations. The game interface 500 includes a locked value-bearing symbol 514 (which operates as a trigger symbol) within the leftmost award group 510 and an initiated subset counter 516. The value-bearing symbol 514 was previously collected from the symbol array 502 and locked into the award group 510 to initiate the subset counter 516. In particular, the value-bearing symbol 514 was collected from the first position subset 504 into the corresponding award group 510. In the example embodiment, the collected trigger symbols are moved into the next available award position 511 from the top of the award group 510. In other embodiments, the trigger symbols are locked into the award groups 510 in another suitable configuration. In one example, each symbol position of the symbol array 502 maps to a respective award position 511, and the trigger symbols are locked into the award position 511 corresponding to the symbol position occupied by the respective trigger symbol.

In the example embodiment, the trigger symbols are presented in a presentation state selected from a plurality of presentation states. The presentation state is selected based on the type of trigger symbol, where the full presentation state is selected for value-bearing symbols, an indirect presentation state is selected for award trigger symbols in which an award value is indirectly identified based on the symbol, and a hidden presentation state is selected for other symbols described herein in subsequent states. In certain embodiments, similar to the embodiments described with respect to FIGS. 7A-7F, the game-logic circuitry may randomly select a presentation state and/or type of trigger symbol for each trigger symbol presented in a game outcome. The trigger symbols may be transitioned between presentation states in response to game events and/or conditions detected within the game feature. For example, a trigger symbol that is part of an award condition may be transitioned to the full presentation state for the award sequence. The presentation assembly is configured to present one or more animations and/or other suitable visual updates to indicate to the player that the presentation state has changed.

FIG. 8B depicts the game interface 500 in a second state following the first state. In the second state, a subsequent game outcome is shown with the symbol array 502 including a new set of randomly selected symbols by spinning and stopping the reel strips. In the illustrated embodiment, the new set of symbols includes two new trigger symbols. In particular, the first position subset 504 includes a hidden award symbol 518 and the second position subset 506 includes a value-bearing symbol 520. In response to detecting the trigger symbols, the presentation assembly is configured to present a collection sequence for animating the trigger symbols (or other graphical elements representing the trigger symbols) to move into the award groups.

FIG. 8C depicts the game interface 500 in a third state following the second state. In the third state, the collection sequence has caused the hidden award symbol 518 and the value-bearing symbol 520 to be presented in the respective award groups 510 associated with the position subsets 504, 506 occupied by the symbols 518, 520, respectively. The hidden award symbol 518 is presented in the hidden presentation state with indicia that visually distinguishes the symbol 518 from locked trigger symbols in other presentation states. The hidden award symbol 518 is associated with a number of award symbol counts used to select an award from the award options 512 as described in detail below. That is, the hidden award symbol 528 is equivalent to one or more award symbols, but the full actual count is not initially presented with the hidden award symbol 518. In one example, the hidden award symbol includes indicia indicating a partial count less than the full count similar to the hidden presentation state symbols in FIGS. 7A-7F. In another example, the indicia (if any) initially presented by the hidden award symbol 518 does not indicate any award symbol count in the hidden presentation state. The full award symbol count associated with a given hidden award symbol may be static or dynamic (i.e., changes in response to game events and/or conditions within the game interface 500).

In response to the hidden award symbol 518 and the value-bearing symbol 520, the subset counter 516 is reset to extend its duration, and a new subset counter 522 is initiated for the second position subset 506 and the corresponding award group 510. The locked trigger symbols remain in the award groups 510 at least until an award condition is detected or the corresponding subset counter 516, 522 has expired.

FIG. 8D depicts the game interface 500 in a fourth state following the third state. The fourth state occurs several game outcomes after the outcome associated with the second and third states. Within the intervening game outcomes, the second position subset 506 has been occupied by two new trigger symbols that have been locked into the corresponding award group: an award symbol 524 and a hidden award symbol 526. The award symbol is configured to provide a single award symbol count towards collecting an award from the award options 512, and the hidden award symbol 526 may be associated with the same or a different award symbol count as the hidden award symbol 518. In some embodiments, the award symbol count of the hidden award symbols 518, 526 varies based on the number of award symbols and/or hidden award symbols present within the award groups 510 as a whole or the same award group 510 as the hidden award symbols 518, 526.

In the fourth state, a new game outcome is depicted with the array 502 populated by a new set of randomly selected symbols, which includes a new value-bearing symbol 528 in the first position subset 504. FIG. 8E depicts a fifth state following the fourth state. In the fifth state, the value-bearing symbol 528 is locked into the award group 510 corresponding to the first position subset 504, and the subset counter 522 is decremented to indicate that the current game outcome did not include any new trigger symbols in the second position subset 506. With the value-bearing symbol 528 locked into the award group 510, an award condition associated with the first position subset 504 and the corresponding award group 510 is achieved, and an award sequence is initiated to provide one or more awards as described herein.

The award sequence may include transitioning one or more locked symbols in one presentation state into another presentation state. In the example embodiment, the hidden award symbol 518 is visually updated to reveal indicia indicating the corresponding award symbol count. In the illustrated embodiment, the indicia of the hidden award symbol 518 is updated to ‘7A’ to reflect the hidden award symbol 518 has an award symbol count of seven. In this example, the hidden award symbol 518 is transitioned from the hidden presentation state to the indirect presentation state similar to the award symbol 524. In other embodiments, the award symbol count of the hidden award symbol 518 is revealed without transitioning to the indirect presentation state, such as updated an additional meter or other element within the game interface 500 based on the award symbol count of the symbol 518.

In response to revealing any hidden award symbol counts, the game-logic circuitry determines whether or not an award selection has been triggered for the award options 512. In the example embodiment, the award symbol count (i.e., the combination of any hidden award symbols and award symbols) within the award group 510 associated with a detected award condition is totaled and compared to one or more threshold counts, such as the threshold counts indicated by the award options 512. Based on the comparison, if the award symbol count has met or exceeded at least one threshold count, an award selection is triggered, and the presentation assembly is configured to present a corresponding award selection sequence. In certain embodiments, the hidden award symbol 518 is configured to include a corresponding award symbol count that guarantees an award selection (i.e., at least three to reach to the lowest threshold in FIG. 8E).

In other embodiments, the award selection determination and/or process may include additional or alternative parameters. In one example, the award selection determination is based on all held award symbols and hidden award symbols within the award groups 510 in response to an award condition. In another example, the award selection determination may be initiated in response to another suitable trigger event, such as detecting a selection trigger symbol (or combination of selection trigger symbols) within the symbol array 502. In yet another example, particularly for an example with limited duration game events and/or game features (e.g., a bonus game feature), the award symbol count is accumulated over a plurality of game outcomes before an award selection is determined. In such an example, a bonus game feature including the game interface 500 may accumulate award symbols and hidden award symbols in response to award conditions until the conclusion of the bonus game, and then the game-logic circuitry causes the presentation assembly to select an award from the award options 512 based on the accumulated count over the duration of the bonus game feature.

In the example embodiment, the award group 510 associated with the first position subset 504 only includes the hidden award symbol 518, and therefore the award symbol count of seven is compared to the award options 512 to select an award. The award selection sequence may include one or more animations and/or visual updates to convey the selection process. In response to the selection and/or absence of a selection if the award symbol count does not meet the threshold counts, the award symbols may be converted into value-bearing symbols, other suitable symbols, or otherwise removed from the game interface 500. The conversion to value-bearing symbols may be based on the selected award from the award options 512.

FIG. 8F depicts the game interface 500 in a sixth state following the fifth state. In the sixth state, the hidden award symbol 518 is further updated to transition to the full presentation state (i.e., a value-bearing symbol). More specifically, the hidden award symbol 518 is updated to include award indicia associated with the award selected from the award options 512 based on the award symbol count of the award group 510 of the first position subset 504 (i.e., a count of seven yielded an award value of ‘1200’). In some embodiments, each award symbol in an award group 510 with a detected award condition is updated to include the selected award value or a value at least partially a function of the selected award value. In one example, the selected award value is divided to populate each of the award symbols in the award group 510, such that collecting the awards from the award symbols results in the selected award value. In other embodiments, the selected award value is applied to a subset of the award symbols or applied to another suitable presentation element of the interface 500 for the player to monitor what values are being awarded (e.g., an award meter). In one example, one or more of the award symbols are updated to include the award indicia of the selected award value while the remaining award symbols do not include award indicia.

Following the sixth state, the award sequence for the award group 510 associated with the first position subset 504 continues with the award values indicated by the symbols 514, 518, 528 being collected and provided as an award to the player. The symbols 514, 518, 528 are removed from the award group 510 and the subset counter 516 is removed from the game interface 500 until a subsequent trigger symbol is detected in the first position subset 504 in a subsequent game outcome. The second position subset 506 and corresponding award group 510 is unaffected by the award sequence, such that the symbols 520, 524, 526 remain locked in the award group 510 with the subset counter 522 being present in the interface 500 until a termination condition (e.g., the subset counter 522 expiring) or an award condition is detected for the second position subset 506 and the corresponding award group 510. If the termination condition is detected, the hidden award symbol 526 may be removed from the game interface 500 with the other symbols 520, 524 without revealing the corresponding award symbol count and/or associated award value. In other embodiments, the hidden count or award value may be revealed or otherwise hinted at through changes and/or animations associated with the hidden award symbol 526 during the removal from the interface 500.

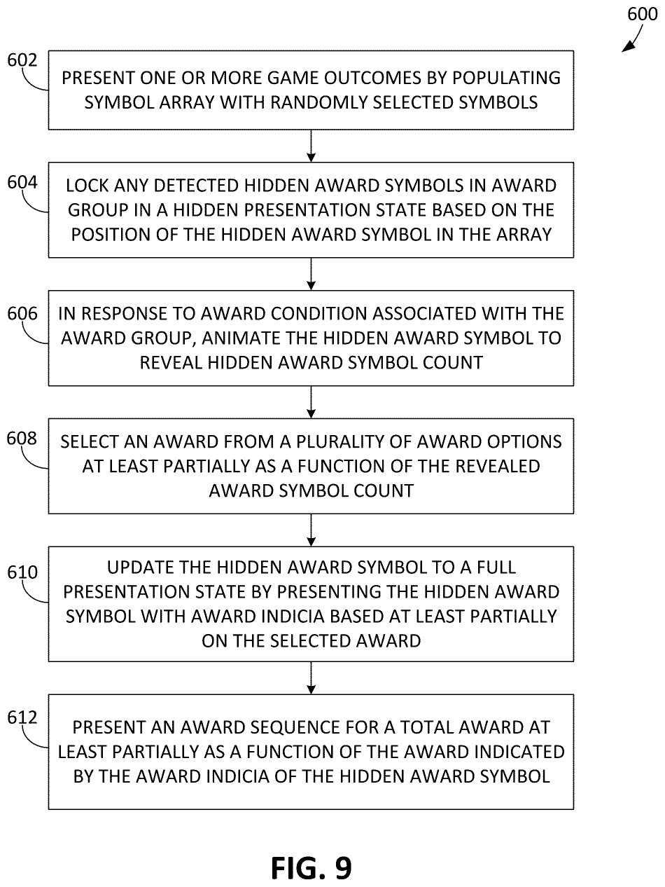

FIG. 9 depicts a flow diagram for an example method 600 of operating a gaming machine of a gaming system (e.g., the system and machine 10 shown in FIGS. 1 and 2) to present one or more game features using award groups and selectable award options. The method 600 is performed by game-logic circuitry of the gaming system in communication with the presentation assembly of the gaming machine. In some embodiments, the presentation assembly of the gaming machine includes a symbol array formed by a plurality of symbol-bearing mechanical reels configured to physically spin via a motor integrated within the gaming machine and randomly stop to reveal the symbols occupying the symbol array. In at least some embodiments, the presentation assembly further includes award groups that are presented off the mechanical reels (e.g., via an electronic presentation device) for collecting trigger symbols from the symbol array. In other embodiments, the reels are digital reels presented by one or more electronic presentation devices and/or the award groups are presented at least partially within the symbol array. In further embodiments, the method 600 is associated with a different game or device configuration and/or includes additional, fewer, or alternative steps, including those described elsewhere herein.

The method 600 is associated with a gaming session by a player at the gaming machine. The player interacts with the gaming machine for the gaming session at least partially through the presentation assembly, which includes visual depictions of the underlying game events and determinations as processed by the game-logic circuitry. The presentation assembly is configured to present one or more game interfaces for one or more game features within the gaming session, and the method 600 is associated with at least one of the game interfaces. In the example embodiment, as referenced above, the game interface includes a symbol array with symbol positions divided into a plurality of position subsets and a plurality of award groups, where each position subset is associated with a respective award group. Additionally, the game interface includes a plurality of selectable award options associated with collectable award symbols, where collecting a threshold count or number of award symbols causes the game-logic circuitry to award the value corresponding to one or more award options. In other embodiments, the game interface includes additional, fewer, or alternative game and/or presentation elements, such as elements described elsewhere herein.

At step 602, the game-logic circuitry is configured to generate one or more game outcomes and cause the presentation assembly to present the one or more game outcomes. Each game outcome includes populating the symbol array with a new set of randomly selected symbols. The symbols may include one or more types of trigger symbols, which are selectively retrieved from the symbol array and held within the corresponding award group. For the first held trigger symbol in an award group, a subset counter is initiated for monitoring a limited duration in which trigger symbols are held in the award group before the locked trigger symbols are removed. New trigger symbols on subsequent game outcomes may cause the subset counter to be reset. Similar to the prior game feature described with respect to FIGS. 8A-8F, the game feature associated with the method 600 includes award conditions for meeting a threshold number of locked trigger symbols within a given award group, such as filling the award group in its entirety with locked trigger symbols. It is to be understood that although the award groups are referenced as “retrieving,” “collecting,” or “locking” trigger symbols, the award groups may include other graphical elements that represent the symbols in place of the symbols.

The trigger symbols available for the game feature may include one or more types of trigger symbols. The trigger symbols may include, for example and without limitation, value-bearing symbols, modifier symbols, jackpot trigger symbols, award symbols, and/or hidden award symbols. The award and hidden award symbols are associated with the selectable award options as described herein.

In response to generating each game outcome, the game-logic circuitry is configured to perform one or more outcome determinations based at least partially on the new set of symbols in the symbol array and causes the presentation assembly is present any corresponding outcome sequences to visually the indicate the presence or absence of certain game events and the resulting game action(s). For example, trigger symbols are detected in each position subset and locked within the corresponding award group. At step 604, in response to detecting any hidden award symbols in the new set of symbols, the presentation assembly locks each of the hidden award symbols in a respective award group based on the position of the hidden award symbol within the symbol array. More specifically, each hidden award symbol is locked into the award group associated with the position subset occupied by the hidden award symbol.

The hidden award symbols are symbols that are initially locked into the award groups in a hidden presentation state such that a corresponding value (directly or indirectly) is not discernable via the appearance of the locked symbol. In the example embodiment, the hidden award symbols count as one or more award symbols towards selecting an award from the selectable award options. In some embodiments, the count or number of award symbols the hidden award symbol is equivalent to is predefined. In other embodiments, the award symbol count is dynamic and may be based on the number of other hidden award symbols present in the award groups and/or other trigger symbols in the award group. In certain embodiments, the award symbol count is at least sufficient to automatically guarantee an award selection from the selectable award options as described herein.

Initially, the hidden value associated with the hidden award symbol is the number or count of award symbols associated with the hidden award symbol. Accordingly, in the hidden presentation state, the hidden award symbol obscures the corresponding award symbol count. Other award symbols may be presented with indicia visually indicating the corresponding award symbol count.

For each game outcome, the game-logic circuitry determines whether or not an award condition has been met for each position subset and corresponding award group. More specifically, the number of locked symbols in each award group is compared to a threshold value, which may be equal to the number of award positions within a given award group. If the number of locked trigger symbols meets or exceeds the threshold value, the award condition for a given position subset and award group has been met. Accordingly, the game-logic circuitry causes the presentation assembly to initiate an award sequence to provide one or more awards based on the locked trigger symbols in the award group associated with the award condition.

For award groups including at least one hidden award symbol, at step 606, the presentation assembly animates the hidden award symbol to reveal the hidden award symbol count. In certain embodiments in which the hidden award symbol count is dynamic, the game-logic circuitry may be configured to generate the hidden award symbol count prior to the reveal. In some embodiments, the animation may include presenting the locked hidden award symbol with indicia visually indicating the hidden award symbol count. In other embodiments, the hidden award symbol count may be revealed and applied external to the locked hidden award symbol, such as a meter for counting award symbols. In revealing the hidden award symbol count, the hidden award symbol may be visually transitioned to a different presentation state, such as an indirect presentation state.

At step 608, the game-logic circuitry causes the presentation assembly to select an award from the selectable award options at least partially as a function of the revealed award symbol count of the hidden award symbol. More specifically, in response to the award condition, the game-logic circuitry is configured to determine a total award symbol count for the award group of the award sequence. The count includes award symbols and the hidden award symbol counts of the hidden award symbols locked into the award group. In other embodiments, the total award symbol count may include additional or alternative award symbols and/or values derived from other trigger symbols. The game-logic circuitry is configured to compare the total award symbol count to one or more threshold counts representing different selectable award options. Based on the comparison, the game-logic circuitry determines whether or not an award selection is to occur, and which award or awards are to be selected if the selection is determined to occur. In at least some embodiments, the hidden award symbol includes a hidden award symbol count that guarantees at least one threshold count is met by the total award symbol count, thereby guaranteeing an award selection. In some embodiments, the highest award is selected based on the comparison. In other embodiments, every award associated with a threshold count achieved by the total award symbol count is selected.

The presentation assembly is configured to present an award selection sequence for the award selection. In some embodiments, at step 610, the award selection sequence includes updating the hidden award symbol to a full presentation state by presenting the hidden award symbol with award indicia based at least partially on the selected award(s) from the award options. In one example, the total award value from the award selection is presented as award indicia by the hidden award symbol. In another example, a portion of the selected award or awards is presented by the hidden award symbol. In such an example, the selected award or awards may be divided amongst other award symbols. For example, the selected award may be divided based on the proportional count of each award symbol within the total award symbol count. In other embodiments, the hidden award symbol is not updated to the full presentation state, but rather the selected award or awards from the award options is presented through other presentation elements within the game interface, such as one or more meters for monitoring awards.

At step 612, the game-logic circuitry causes the presentation assembly to continue the award sequence by presenting a total award at least partially as a function of the award indicated by the award indicia of the hidden award symbol and/or the selected award(s). In other embodiments, the selected award is provided via a separate award sequence, and the award sequence of step 612 accumulate award values from value-bearing trigger symbols, modifier trigger symbols, and the like to provide a total award value to the player. The award sequence includes one or more animations for visually indicating the award and game elements associated with the award. The award sequence may include visually updating one or more meters for monitoring awards and/or a credit balance of the player with the total award value.

The award sequence may include removing the subset counter and any locked symbols associated with the award sequence from the game interface, thereby facilitate the opportunity for new trigger symbols to be detected and locked into the award group during subsequent game outcomes.

Although the systems and methods are described above with respect award conditions based on locking trigger symbols within award groups and/or position subsets, other suitable embodiments of the present disclosure use other suitable means of detecting award conditions. For example, instead of locking the trigger symbols into position subsets and/or award groups, the trigger symbols may leave behind a trigger frame, causing a corresponding subset counter to initiate or reset. In such embodiments, the game-logic circuitry compares the number of trigger frames to a threshold number associated with the position subset and/or award group to determine whether or not an award condition is present. If the award condition is detected, the trigger frames are animated to reveal one of more hidden prizes, which may include value-bearing symbols to be awarded. Accordingly, the trigger frames are initially locked in a hidden presentation state and transition to a full presentation state in response to a detected award condition similar to the value-bearing symbols and hidden award symbols in the hidden presentation state in FIGS. 7A-7F and FIGS. 8A-8F, respectively.

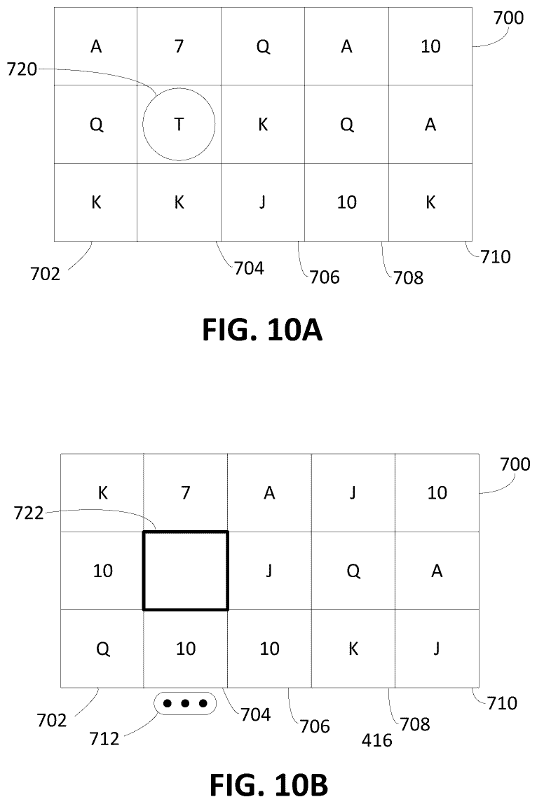

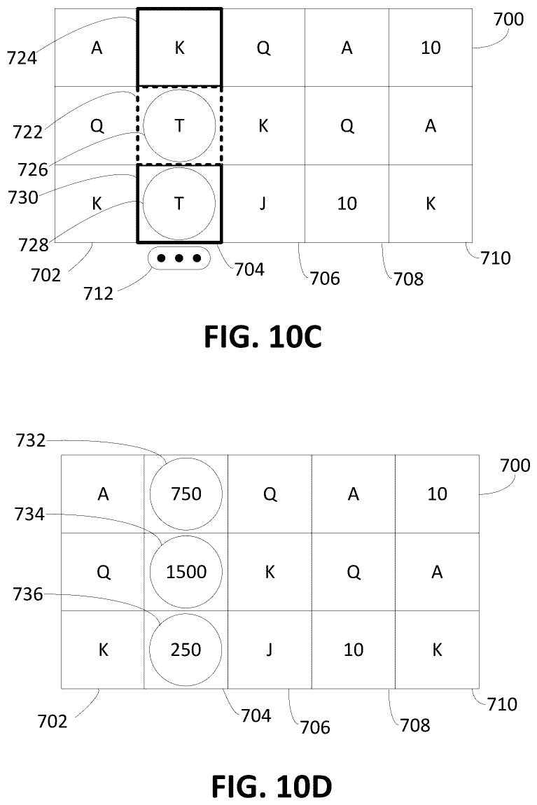

FIGS. 10A-10D depict an example game interface in several states, where the game interface includes a symbol array 700 similar to the symbol array shown in FIGS. 5A-5F and 7A-7F. The game interface is presented by a presentation assembly of a gaming machine (e.g., the machine 10 shown in FIGS. 1 and 2). The presentation assembly is in communication with game-logic circuitry of a gaming system including the gaming machine to provide the functionality described herein. The symbol array 700 includes a plurality of symbol positions arranged into five position subsets 702, 704, 706, 708, 710 or columns of the array 700. In other embodiments, the symbol array 700 may include additional or fewer symbol positions and/or a different configuration of position subsets. In the example embodiment, the position subsets 702, 704, 706, 708, 710 also operate as award groups for locking trigger frames as described herein. In other embodiments, the award groups may be separate game and/or presentation elements from the symbol array 700. In one or more embodiments, the award groups include the position subsets 702, 704, 706, 708, 710 and a plurality of additional award positions beyond the symbol array 700.

FIG. 10A depicts the symbol array 700 with the game interface in a first state. In the first state, the symbol array 700 is populated by randomly selected symbols that include a trigger symbol 720 in the second position subset 704. The second position subset 704 does not have an active subset counter in the first state, and, as a result, a subset counter is initiated for the second position subset 704.

FIG. 10B depicts the game interface in a second state following the first state. In the second state, the presentation assembly presents a subset counter 712 in an initial state for the second position subset 704 and the trigger symbol 720 is converted into or otherwise leaves behind a trigger frame 722. The trigger frame 722 operates similar to the locked trigger symbols described in other embodiments, but also enables other symbols to occupy the symbol position in subsequent game outcomes while the trigger frame 722 is active. As described herein, the trigger frame 722 is associated with one or more hidden awards. The awards may be credit awards and/or other suitable awards, such as free game outcomes, multipliers, progressive jackpot triggers, and the like. In some embodiments, the hidden award associated with a given trigger frame may be predefined. In other embodiments, the hidden award may be determined through one or more random selections performed by the game-logic circuitry as described herein.

The trigger frame 722 is presented in the hidden presentation state in the second state shown in FIG. 10B. That is, the underlying value associated with the trigger frame is not discernable by a player from the appearance of the trigger frame 722. In at least some embodiments, while the particular award is not visually discernable, the trigger frames may be configured to be presented in different presentation states according to different levels or tiers of the hidden award associated with a given frame.

FIG. 10C depicts the game interface in a third state in which a subsequent game outcome is shown. Between the second and third states, a new trigger symbol was detected in the second position subset 704 and the presentation assembly has locked a corresponding trigger frame 724 into the second position subset 704. In the game outcome of the third state, two new trigger symbols 726, 728 occupy the second position subset 704, and the corresponding frames are shown. In particular, the trigger symbol 726 occupies the symbol position associated with the trigger frame 722, and a new trigger frame 730 is activated in response to the trigger symbol 728 occupying the last symbol position without a trigger frame. In the example embodiment, the trigger symbol 726 causes the trigger frame 722 to be upgraded to a different tier or level of trigger frame. Each incremental tier or level of trigger frame may cause the hidden award to be enhanced (including providing additional new awards) or the hidden award to be selected from a new set of awards having a relatively higher average value than the prior tier of level. In other embodiments, a trigger symbol occupying a position with an active trigger frame may have an additional or alternative effect, such as applying a trigger frame to a symbol position without one or automatically initiating an award sequence for the trigger frame or the position subset as a whole irrespective of meeting the threshold number of trigger frames.

By filling the position subset 704 with trigger frames 722, 724, 730, an award sequence is initiated for the second position subset 704. More specifically, the presentation assembly is configured to present one or more animations that reveal awards associated with each trigger frame 722, 724, 730 of the second position subset 704. FIG. 10D depicts the game interface in a fourth state following the third state. In the fourth state, the presentation assembly has revealed a corresponding award for each frame 722, 724, 730. More specifically, in the example embodiment, each frame 722, 724, 730 reveals a value-bearing symbol 732, 734, 736, respectively. The value-bearing symbols 732, 734, 736, similar to the value-bearing symbols of other embodiments of the present disclosure, are aggregated or otherwise used to functionally generate an award value to be provided to the player within the award sequence. The values of the value-bearing symbols 732, 734, 736 are selected at least partially based on the level or tier of the respective frame 722, 724, 730. That is, because the trigger frame 722 was upgraded relative to the other trigger frames 724, 728, the award for the value-bearing symbol 734 is relatively greater than the values of the other value-bearing symbols 732, 736. In other embodiments, additional or alternative awards may be revealed by the trigger frames 722, 724, 730 in the award sequence. In one example, one or more spins of an award wheel or picks of a prize board may be awarded. In another example, a multiplier or other modifier may be awarded to be applied to another award value.

Similar to the trigger symbols of the other embodiments of the present disclosure, the trigger frames 722, 724, 730 and the subset counter are removed from the game interface in response to the award sequence to await new trigger symbols in subsequent game outcomes. Likewise, for trigger frames locked into a position subset with an expired subset counter, the trigger frames are removed without award, thereby resetting the position subset to initiate a new subset counter. Moreover, new trigger symbols within a position subset with an active subset counter causes the subset counter to reset and extend the remaining duration of the counter. Accordingly, the features and functionality of the various embodiments of the present disclosure as described above may be interconnected and adapted through the teachings of each embodiment to provide various game configurations and presentations.

In the embodiments disclosed herein, each value-bearing symbol may be assigned a credit value that is displayed upon the symbol. The credit value may, for example, range from a minimum credit value to a maximum credit value and be based on the total amount wagered on the game. For example, if a player wagers a minimum of 100 credits, the assigned credit value may range from 100 to 1000 credits. And if a player wagers a maximum of 500 credits, the assigned credit value may proportionately increase and thereby range from 500 to 5000 credits. In some embodiments, the assigned value may be randomly selected from a list of possible multipliers of the total amount wagered on the game, for example, 1×, 2×, 3×, 4×, 5×, 10×, 15×, 20×, 50×, and 100×. In other embodiments, the value may be pre-assigned to each value-bearing symbol as part of the reel strip layouts of the game reels. In still other embodiments, the assigned value may be randomly selected before, during, or at the conclusion of a reel spin.

As disclosed in the embodiments herein, awards may be provided for each game outcome based on at least the remaining symbols. For example, line pays and scatter pays may be awarded for each game cycle outcome based on the symbols populating the symbol array. In some embodiments, the value-bearing symbols may not be associated with awards outside of the features described herein. In other embodiments, the value-bearing symbols may be included within line pays, scatter pays, and/or other suitable awards. For example, the value-bearing symbols may be treated as a special symbol, such as a wild symbol.

While the embodiments are largely described within the context of a base game, it is equally contemplated that the disclosed embodiments can be practiced within the context of a free game bonus without a wager between free game cycles.

The embodiments of the present invention provide an innovative procedure for hiding, revealing, and awarding values of symbols in a symbol array. Game-logic circuitry executing instructions in accordance with the embodiments present a visual display of spinning reels with clearly enumerated symbology that combine in readily understood arrangements to increase in value. An observer experiences excitement and anticipation as new symbols land in the array, previously hidden values are revealed, and aggregate values are summed and displayed. In stark contrast to conventional reel-spinning games in which symbol images are evaluated for winning combinations by paytable rules, the disclosed embodiments provide immediately recognizable values in WYSIWYG display configurations while adding variability as to how the values to be awarded to the player are selected and accumulated.

The presentation state selection, value-reveal, value-aggregation, and value-alteration procedures may be symbol-and game-agnostic. Themes and imagery of symbols and environment may be varied with no effect on the value-aggregation process. Or, if so desired, the criteria for value-aggregation may be modified in innumerable ways to produce new visual/animation effects and exciting summation sequences.

Further benefits are realized in increased computer processing efficiency, fewer rules to be evaluated, and simpler graphical representations. For example, in a conventional paytable evaluation, overlapping payline sections require multiple evaluation steps. Often, analysis is required to determine which payline results in the highest credit total, with the lesser value paylines being discarded but only after being evaluated—all this adds to processing overhead. Special symbols like wilds, multipliers, and scatter symbols can modify paytable values and may require separate, additional evaluation according to customized rule sets. All these procedures can be inherently more complex than simple aggregation (i.e., addition) and alteration of number values, which includes revealing previously hidden values. The embodiments disclosed herein represent a win-win: simpler, almost self-explanatory graphics combined with faster, more efficient processing. The inventive value-aggregation procedure can be implemented on the vast majority of casino gaming machines without requiring upgrades or modifications.

In this description, numerous specific details are set forth. However, it is understood that embodiments of the invention may be practiced without these specific details. In other instances, well-known circuits, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming machine comprising:
a presentation assembly configured to present a plurality of award groups and a symbol array including a plurality of symbol positions arranged into a plurality of position subsets; and
game-logic circuitry in communication with the presentation assembly, the game-logic circuitry configured to:
cause the presentation assembly to present a first game outcome by populating the symbol array with a plurality of randomly selected symbols from one or more sets of available symbols including trigger symbols and value-bearing symbols, each of the value-bearing symbols including award indicia visually indicating a respective award value associated with the value-bearing symbol, wherein the trigger symbols include one or more of the value-bearing symbols;
in response to the first game outcome including at least one trigger symbol in a first subset of the plurality of subsets, cause the presentation assembly to lock the at least one trigger symbol in a first award group of the plurality of award groups that is associated with the first subset;
initiate a subset counter associated with the first subset to an initial count in response to the first game outcome and cause the presentation assembly to present the subset counter;
with the at least one trigger symbol locked in the first award group, cause the presentation assembly to present at least one subsequent game outcome by populating the symbol array with another plurality of randomly selected symbols for each of the at least one subsequent game outcome;
in response to detecting a value-bearing trigger symbol occupying the first subset within the at least one subsequent game outcome, select a presentation state of the value-bearing trigger symbol, wherein the presentation state is selected from a set of states comprising a full presentation state and a hidden presentation state;
cause the presentation assembly to lock the value-bearing trigger symbol within the first award group based on the selected presentation state, wherein the full presentation state includes presenting the value-bearing trigger symbol with award indicia matching a first award value associated with the value-bearing trigger symbol, and the hidden presentation state includes visually obscuring a relationship between the value-bearing trigger symbol and the first award value;
in response to a number of trigger symbols within the first award group meeting a trigger amount, cause the presentation assembly to present an award sequence to provide an award at least partially as a function of the first award value and respective award values associated with other trigger symbols in the first award group, wherein the award sequence includes updating the value-bearing trigger symbol in the hidden presentation state to the full presentation state; and
in response to the subset counter meeting a termination count, cause the presentation assembly to remove any locked trigger symbols from the first award group.

2. The gaming machine of claim 1, wherein locking the value-bearing trigger symbol with the selected presentation state as the hidden presentation state includes:
generating a partial award value at least partially as a function of the first award value, the partial award value less than the first award value; and
presenting, via the presentation assembly, the award indicia visually indicating the partial award value, wherein the award sequence includes visually updating the award indicia from the partial award value to the first award value.

3. The gaming machine of claim 1, wherein each position subset of the plurality of position subsets is a respective award group of the plurality of award groups, where symbols locked within the plurality of award groups are locked within symbol positions of the symbol array.

4. The gaming machine of claim 1, wherein each subset of the plurality of position subsets is a column of the symbol array.

5. The gaming machine of claim 1, wherein transitioning locked symbols from the hidden presentation state to the full presentation state is limited to locked symbols associated with an award sequence.

6. The gaming machine of claim 1, wherein the selection of the presentation state is at least partially a function of one or more random values generated by a random number generator of the game-logic circuitry.

7. The gaming machine of claim 1, wherein the selection of the presentation state is based on a trigger symbol type of the value-bearing trigger symbol.

8. A method for operating a gaming machine of a gaming system, the gaming system including game-logic circuitry in communication with a presentation assembly of the gaming machine, the method comprising:
presenting, via the presentation assembly, a plurality of award groups and a symbol array including a plurality of symbol positions arranged into a plurality of position subsets;
causing, by the game-logic circuitry, the presentation assembly to present a first game outcome by populating the symbol array with a plurality of randomly selected symbols from one or more sets of available symbols including trigger symbols and value-bearing symbols, each of the value-bearing symbols including award indicia visually indicating a respective award value associated with the value-bearing symbol, wherein the trigger symbols include one or more of the value-bearing symbols;
in response to the first game outcome including at least one trigger symbol in a first subset of the plurality of subsets, causing, by the game-logic circuitry, the presentation assembly to lock the at least one trigger symbol in a first award group of the plurality of award groups that is associated with the first subset;
initiating, by the game-logic circuiting a subset counter associated with the first subset to an initial count in response to the first game outcome and causing the presentation assembly to present the subset counter;
with the at least one trigger symbol locked in the first award group, causing, by the game-logic circuitry, the presentation assembly to present at least one subsequent game outcome by populating the symbol array with another plurality of randomly selected symbols for each of the at least one subsequent game outcome;
in response to detecting a value-bearing trigger symbol occupying the first subset within the at least one subsequent game outcome, selecting, by the game-logic circuitry, a presentation state of the value-bearing trigger symbol, wherein the presentation state is selected from a set of states comprising a full presentation state and a hidden presentation state;
causing, by the game-logic circuitry, the presentation assembly to lock the value-bearing trigger symbol within the first award group based on the selected presentation state, wherein the full presentation state includes presenting the value-bearing trigger symbol with award indicia matching a first award value associated with the value-bearing trigger symbol, and the hidden presentation state includes visually obscuring a relationship between the value-bearing trigger symbol and the first award value;
in response to a number of trigger symbols within the first award group meeting a trigger amount, causing, by the game-logic circuitry, the presentation assembly to present an award sequence to provide an award at least partially as a function of the first award value and respective award values associated with other trigger symbols in the first award group, wherein the award sequence includes updating the value-bearing trigger symbol in the hidden presentation state to the full presentation state; and
in response to the subset counter meeting a termination count, causing, by the game-logic circuitry, the presentation assembly to remove any locked trigger symbols from the first award group.

9. The method of claim 8, wherein locking the value-bearing trigger symbol with the selected presentation state as the hidden presentation state includes:
generating a partial award value at least partially as a function of the first award value, the partial award value less than the first award value; and
presenting, via the presentation assembly, the award indicia visually indicating the partial award value, wherein the award sequence includes visually updating the award indicia from the partial award value to the first award value.

10. The method of claim 8, wherein each position subset of the plurality of position subsets is a respective award group of the plurality of award groups, where symbols locked within the plurality of award groups are locked within symbol positions of the symbol array.

11. The method of claim 8, wherein each subset of the plurality of position subsets is a column of the symbol array.

12. The method of claim 8, wherein transitioning locked symbols from the hidden presentation state to the full presentation state is limited to locked symbols associated with an award sequence.

13. The method of claim 8, wherein the selection of the presentation state is at least partially a function of one or more random values generated by a random number generator of the game-logic circuitry.

14. The method of claim 8, wherein the selection of the presentation state is based on a trigger symbol type of the value-bearing trigger symbol.

15. A gaming system comprising:
a gaming machine comprising a presentation assembly configured to present a plurality of award groups and a symbol array including a plurality of symbol positions arranged into a plurality of position subsets; and
game-logic circuitry in communication with the presentation assembly, the game-logic circuitry configured to:
cause the presentation assembly to present a first game outcome by populating the symbol array with a plurality of randomly selected symbols from one or more sets of available symbols including trigger symbols and value-bearing symbols, each of the value-bearing symbols including award indicia visually indicating a respective award value associated with the value-bearing symbol, wherein the trigger symbols include one or more of the value-bearing symbols;
in response to the first game outcome including at least one trigger symbol in a first subset of the plurality of subsets, cause the presentation assembly to lock the at least one trigger symbol in a first award group of the plurality of award groups that is associated with the first subset;
initiate a subset counter associated with the first subset to an initial count in response to the first game outcome and cause the presentation assembly to present the subset counter;
with the at least one trigger symbol locked in the first award group, cause the presentation assembly to present at least one subsequent game outcome by populating the symbol array with another plurality of randomly selected symbols for each of the at least one subsequent game outcome;
in response to detecting a value-bearing trigger symbol occupying the first subset within the at least one subsequent game outcome, select a presentation state of the value-bearing trigger symbol, wherein the presentation state is selected from a set of states comprising a full presentation state and a hidden presentation state;
cause the presentation assembly to lock the value-bearing trigger symbol within the first award group based on the selected presentation state, wherein the full presentation state includes presenting the value-bearing trigger symbol with award indicia matching a first award value associated with the value-bearing trigger symbol, and the hidden presentation state includes visually obscuring a relationship between the value-bearing trigger symbol and the first award value;
in response to a number of trigger symbols within the first award group meeting a trigger amount, cause the presentation assembly to present an award sequence to provide an award at least partially as a function of the first award value and respective award values associated with other trigger symbols in the first award group, wherein the award sequence includes updating the value-bearing trigger symbol in the hidden presentation state to the full presentation state; and
in response to the subset counter meeting a termination count, cause the presentation assembly to remove any locked trigger symbols from the first award group.

16. The gaming system of claim 15, wherein locking the value-bearing trigger symbol with the selected presentation state as the hidden presentation state includes:
generating a partial award value at least partially as a function of the first award value, the partial award value less than the first award value; and
presenting, via the presentation assembly, the award indicia visually indicating the partial award value, wherein the award sequence includes visually updating the award indicia from the partial award value to the first award value.

17. The gaming system of claim 15, wherein each position subset of the plurality of position subsets is a respective award group of the plurality of award groups, where symbols locked within the plurality of award groups are locked within symbol positions of the symbol array.

18. The gaming system of claim 15, wherein transitioning locked symbols from the hidden presentation state to the full presentation state is limited to locked symbols associated with an award sequence.

19. The gaming system of claim 15, wherein the selection of the presentation state is at least partially a function of one or more random values generated by a random number generator of the game-logic circuitry.

20. The gaming system of claim 15, wherein the selection of the presentation state is based on a trigger symbol type of the value-bearing trigger symbol.
